(19) United States
(12) Patent Application Publication
(10) Pub. No.: US 2005/0102287 A1
(43) Pub. Date: May 12, 2005

(54) Electronic messaging and information management method and system

(75) Inventor: Nicholas Richard Poole, Birmingham (GB)

Correspondence Address: Derek C. Stettner;Michael Best & Friedrich LLP, 100 East Wisconsin Avenue, Milwaukee, WI, 53202-4108, US

(73) Assignee: Delcam PLC, Birmingham (GB)

(21) Appl. No.: 10/915,886

(22) Filed: Aug. 11, 2004

Related U.S. Application Data
(63) Continuation of application No. 09/659,097, filed on Sep. 11, 2000, now abandoned.

(51) Int. Cl. G06F 7/00

(52) U.S. Cl. 707/9

(57) ABSTRACT

An electronic messaging and information management system and method. The system includes a network of computers that communicate with each other via electronic communications such as e-mail. Users of the system are assigned unique identifiers and categorized into one of a hierachy of classes. The users may generate and review information records. The information records are maintained in a database and associated with specific users depending on the user's class and interest in the subject of the information records. The system generates messages to notify users of the system of modifications

### CROSS-REFERENCE TO RELATED APPLICATIONS

This is a continuation of U.S. patent application Ser. No. 09/659,097 filed on Sep. 11, 2000, the entire contents of which are incorporated herein by reference.

### BACKGROUND OF THE INVENTION

The present invention relates to information management systems and methods of managing information. More particularly, the invention relates to an electronic messaging system with information management features and methods for managing information with electronic messaging systems.

A large amount of information is generated within any environment or situation where project management occurs. Databases and contact management systems that allow project information to be stored in a logical and ordered manner are well known. However, such systems are not proactive and rely on the users' discipline to check, use, and update the information within them. In many instances, users do not gain full advantage of information management systems because the users lack the discipline to fully use the systems.

### SUMMARY OF THE INVENTION

Accordingly, it would be desirable to have an information management system that is more proactive and easier to use than prior systems and methods. The invention provides a method of managing information that includes connecting two or more computers in a network, assigning unique identities to users of the network, generating one or more information records and maintaining these records in a database, associating information records with one or more uniquely identified users, providing access to the database from at least one of the computers in the network, and alerting with an electronic communication each uniquely identified user that is associated with an information record when that information record is modified. Preferably, each information record relates to substantially a single subject or topic.

The invention provides active announcements that information records have been modified. Modification announcements help users of the system manage the information contained therein by providing a timely prompt to act upon the change, if so desired by the user.

It will be appreciated that modification of an information record encompasses the creation of a new information record. Accordingly, the invention also notifies users by an electronic communication when an information record is created.

Preferably, the electronic communications are messages sent by email software. This is advantageous because it makes use of an existing technology and, therefore, the amount of extra programming required is reduced. The email-handling software may be adapted so that email messages generated by the information system are automatically delivered to a specified folder in a user's computer. It will be appreciated that in a standard email-handling package new email messages are generally directed into a general “inbox.” Automatically directing email messages to specified folders increases the organization of information received by the user making it easier for the user to process their messages. The term folder is intended to mean any directory, folder, or other means of classifying and facilitating the storage of data.

The invention allows users of the system to respond to the electronic communications sent by the system. The responses are added to the information records relevant to the communications. The addition of the comments to the information record builds a history of how the subject was processed by the addition of the comments, thereby providing an audit trail.

The invention may include assigning specific information records to users of the system with work or tasks specified therein. The invention may also include using comments added to the information record to track the progress of the specified tasks. This history of the information record provides an audit trail that can show the steps or procedures used to complete a task. For example, audit trails can also be used to generate a report on the solution or to assist in the solution of similar problems that arise in the future.

Another feature of the invention allows a user to assign work involved in processing a particular comment to another user of the system. It will be appreciated that as a task is processed it may be passed to different users with different areas of expertise. Being able to assign additional comments to different users allows the actual workflow to be mirrored by the information record. Preferably, the information record reflects to whom each additional comment has been assigned. Further, the invention sends an electronic communication to each assignee of an information record, alerting a particular user that work has been assigned to them.

In one embodiment, the invention involves inserting hypertext links within the information records. The hypertext links connect the records to other information content in the system and make navigation and location of information in the system easier and more intuitive. Hypertext links may be provided within an information record to other information sources including indexes, associated information records, and summary tables.

The invention may be designed such that comments added to an information record have associated tracing information such as the time the comment was added, the date the comment was added, and the identity of the person adding the comment. Preferably, all of the comment tracking or tracing information is added to the information record when a comment is added.

In one embodiment of the invention, the information system is arranged to allow the information records to be viewed using a browser, such as the Microsoft Explorer™ or Netscape Navigator™ browser. When browser-enabled, the invention allows the user to use browsing functions such as forward and back buttons, and the browsing history. Further, each screen within the system may be given a useful title enabling favourite screens to be set within the system and consequently accessed easily.

The invention may also be designed to restrict or control access to information records. Access may be controlled by way of password and/or user name.

Preferably, there are different classes of users within the system, each having different rights in relation to information records. Different users may be given a different user class in relation to different information records. This allows access to the information record to reflect a specific user's rights to the content of the information record. In many instances, it is likely that tasks will fall across different users' responsibilities within a particular environment. It is advantageous to tailor access rights to an information record according to who has the responsibility for the work therein.

Information records may be grouped together within subjects or topics that contain information records relating to similar tasks, or tasks connected in some way. As an example, a topic may be set up that relates to building maintenance and each record within the topic may relate to a specific problem or task relating to maintenance of the building. An advantage of such grouping is that it allows information records to be logically ordered and makes them easier to find.

Users may be able to register with a topic and, in one embodiment, each registered user is sent an electronic communication when an information record within that topic is modified. Registering with a topic in this manner provides a convenient way of allowing the information system to notify users of newly created or modified information records in which they may be interested. Without a topic system, it would be difficult for a user to express, or register, an interest in an information record that has yet to be created (whereas the topic system allows interests to be registered in yet to be created information records).

Preferably, a level one user or topic administrator, a single user sometimes referred to as a “Demi-God,” is assigned to control information records within a topic. Information records within a single topic generally relate to similar subjects or tasks such that it is generally feasible for a single user to manage the topic. Different users may be given different access rights in relation to different topics.

The topic administrator can control any of the following aspects: who can create information records within the topic, who can modify information records within the topic. The topic administrator may also set topic preferences (which may be to enable priorities, set up projects, etc.). The topic administrator may be thought of as the controller of the topic, setting the “tone” for the topic and making sure that it runs smoothly.

The invention provides a hierarchy of users below the topic administrator. A level-two user or assistant administrator, sometimes referred to as an “Acolyte,” has access rights that allow him or her to create information records within a topic. Assistant administrators are, in general, people that work in a particular area of a topic and, therefore, need to create new information records to reflect the work they are performing.

Level-three users, sometimes referred to as passive participants or “passive participants,” are one class below assistant administrators. Passive participants have access rights that allow them to receive electronic communications when relevant information records are created or modified, but they do not have the ability to create information records. Passive participants generally have a peripheral interest to work in a topic and, therefore, wish to receive updates about work carried out in relation to that topic. However, since passive participants are not directly involved, they do not need the ability to create information records.

Each user and therefore, each topic administrator, assistant administrator, and passive participant may be given a unique identity. The electronic communication sent to each uniquely identified user may include a summary portion showing the change in the information record. This allows the recipient to readily identify the changes made to a particular information record. The electronic communication may also include the content or text of the information record. Providing the text in this manner allows the recipient to review the change in context of what has gone before and so refresh their memory as to the task.

Each electronic communication may also include one or more hypertext links that are arranged to allow the recipient to make a reply to a topic. The hypertext link may increase the ease with which the information record can be maintained. Hypertext links may also be included to provide a connection to a screen, or page, showing the text of the information record. This is advantageous because, in the preferred embodiment, it allows the user to proceed directly from an email into the information database, at the correct point, and then use their web browser to see the information record in context.

The lowest class of user, a level-four user in the exemplary embodiments described herein, receives summaries or digests of changes in a topic. A level-four user, sometimes referred to as a “Digest Recipient,” generally has only a passing level of interest in work within a particular topic and can be satisfied by summary communications. Of course, summaries may also be sent to other users of the system. The summaries may be delimited by date or another time period in order to reduce the amount of communications that a particular user receives. The frequency of transmission may also be controlled such that communications are sent hourly, daily, weekly, monthly, or any period between any one of these periods. Preferably, summary communications are sent weekly. Transmission of summary communications may be triggered on predetermined criteria or by the act of a high-level user.

A summary communication may refer to a plurality of information records. Each reference to an information record may be provided with a hypertext link to the text of that information record. Such a hypertext link is advantageous because it allows the user to view the entire content of any information record in which they are interested.

Specific pieces of work, or projects, may cover information records in more than one topic. Therefore, the invention allows information records to be assigned to specific projects as well as specific topics. Such projects may allow tasks contained within a variety of information records to be brought together for ease of reference.

Different classes of users may be assigned to each project in the same manner that different classes of users are assigned to different topics. It is, therefore, possible for the manager in charge of a piece of work to oversee and control a particular project.

Effort estimates may be assignable to tasks detailed in information records. Only certain classes of users (for example, the topic administrator) may assign effort estimates. These effort estimates are advantageous because they allow the amount of work in a certain project to be estimated. Summary screens may be provided allowing the effort estimates to be viewed. Summary screens allow the estimated amount of work and the overall workload of a user to be viewed. This makes it possible to review the distribution of work.

Due dates may be assigned to tasks specified within an information record. In the preferred embodiment only information records within a specified project are assigned a due date.

The invention provides a mechanism for assigning different statuses to information records within the information system. These statuses allow the current situation of the tasks within information records to be reflected. For example, there may be a closed status to which information records can be assigned when the task therein is completed. There may be an unassigned status to which newly created information records are assigned before they have been made the responsibility of a user. There may be an assigned status to which information records are assigned once they have been assigned to one or more users. There may be a wish status to which information records are assigned if they contain ideas, which although worthwhile, are not applicable at the present time.

The invention may also include search tools that allow the information records to be searched. The search tools allow the various aspects to be searched and may include any of the following: occurrence of certain text strings within information records; information records created on, after, or before a certain date; information records associated with a particular unique identity; information records created by particular unique identity; information records having a particular status (for example, assigned, unassigned, closed, wish, etc).

The method may include providing a mode that suspends electronic communications to one or more unique identities. The suspend mode suspends electronic communications when a user is away on holiday or otherwise away from the system. The suspend mode is advantageous because it helps to prevent an accumulation of electronic communications whilst the user is not reviewing them. For example, the user email inbox (or other specified folder) will not contain a large number of unread emails that have been automatically generated by the information system on his/her return from holiday.

Summary electronic communications may be sent when the suspend mode is de-activated to provide a synopsis of all the communications that were not sent to the user when the suspend mode was activated. This feature allows the user to review just what has occurred on information records in which they are interested without having to review large amounts of information in detail.

Preferably, a summary electronic communication contains hypertext links to information records to which it refers. The hypertext links allow the user to easily access information records that they wish to review in more detail.

A user may be presented with a home screen, or page, that provides summary tables showing all of the topics within the system. Further, the home screen may contain a menu providing access to commonly used features of the system. Both of these features of the home screen allow users to access the information they are after easily and quickly.

Priorities may be assigned to the information records. In the preferred embodiment, priorities of one, two, or three, can be assigned to any information record of the system. Priorities are advantageous because they make the urgency of the task contained in the information record readily apparent.

In one embodiment of the invention, if the user creating an information record does not assign a priority to an information record, the system assigns a default priority. Each information record created under a specific topic and/or project may be assigned a default priority depending on that topic and/or project. This allows the default priority to be varied according to the urgency of the overall project/topic; some projects/topics will be of higher importance than others.

Users of the system may be sent a summary electronic communication summarizing information records that have been assigned to that user with tasks still outstanding therein (an outstanding task communication). This is beneficial because it proactively helps to ensure that tasks are not forgotten. The database as a whole contains information as to tasks that are still outstanding, but this relies on users looking in the correct places to see what is yet to be performed. Sending outstanding task communications helps to ensure that tasks are not overlooked.

The outstanding task communication may be sent at predetermined periods, such as hourly, daily, weekly, monthly, or fractions thereof. In the preferred embodiment, the communication is sent weekly.

The invention may be adapted to run across a network of a plurality of computers, but is particularly suited for running in association with an intranet. Different access rights may be given to people accessing the system locally when compared to people accessing the system remotely. The system may also be run across the Internet, or World Wide Web.

In one embodiment of the invention, a form for creating information records is provided. The form conveniently has input areas allowing the necessary information to be specified. In particular, the input areas may include drop down boxes with delimited fields having a finite range of possibilities and containing all of the available options; and text boxes, allowing text to be entered. Statistic screens may be provided within the system to allow a summary of the information held within the information system to be seen.

The invention may also include an interface with a menu bar. The menu bar may provide links or selections to a one or more parts of the information system. The menu bar is provided with a context specific portion that is provided when it is relevant. Such a menu bar is advantageous because it stops the user from being provided with too many options and makes navigation of the information system easier.

According to a second aspect of the invention there is provided a method of processing information, the method comprising:
maintaining a database of information records on a central server;
accepting signals from at least one remote computer; and
if said signals cause any of said information records to be modified causing an electronic communication to be sent to a user of the system alerting said user about the modification of said information record.

An advantage of such a method is that it provides positive notifications that an information record has been modified. As with the first aspect of the invention it will be appreciated that modification of an information record may include the creation of a new information record as well as the alteration of an existing information record.

According to a third aspect of the invention there is provided a method of maintaining an information database, the method comprising:
allowing a user having assigned thereto a unique identity to access a remote database comprising one or more information records;
allowing said information records to be viewed and/or modified and subsequently causing signals to be sent to said remote database updating said database accordingly; and
arranging to receive electronic communications from said remote database indicative that information records that are associated with said unique identity have been modified.

According to a fourth aspect of the invention there is provided a computer readable medium having stored therein instructions for causing a processing unit to execute the method of any of the first, second or third aspects of the present invention.

According to a fifth aspect of the invention there is provided a computer program for maintaining a database of information records, the program comprising:
code for maintaining said database;
code for maintaining a list of users, each of said users having a unique identity assigned thereto;
code for associating information records within said database to one or more unique identities;
code for allowing information records within said database to be viewed and/or updated; and
code for causing electronic communications to be sent to each identity associated with a particular information record if that information record is modified.

According to a sixth aspect of the invention there is provided a computer system running the method of any of the first, second, or third aspects of the system.

According to a seventh aspect of the invention there is provided a computer system running the computer program of the fifth aspect of the invention.

As is apparent from the above, it is an advantage of the present invention to provide a method and system for managing information shared among users. Other features and advantages of the present invention will become apparent by consideration of the detailed description and accompanying drawings.

### BRIEF DESCRIPTION OF THE DRAWINGS

In the drawings:

FIG. 1A is an illustration of a system embodying the invention.

FIG. 1 is an illustration of a home page of the invention.

FIG. 2 is an illustration of the links from menu options on the home page to additional pages in the invention.

FIG. 3 is an illustration of a statistics interface.

FIG. 4 is an illustration of a topic overview interface.

FIG. 5 is an illustration of a new information record interface.

FIG. 6 is an illustration of an assignment interface.

FIG. 7 is an illustration of an information records interface.

FIG. 8 is an illustration of an information record wishes interface.

FIG. 9 is an illustration of a search tool.

FIG. 10 is an illustration of an index of unassigned information records.

FIG. 11 is an illustration of an unassigned information record.

FIG. 12 is an illustration of information records in a specific topic.

FIG. 13 is an illustration of an active information record in a specific topic.

FIG. 14 is an illustration of an information record wish index for a specific topic.

FIG. 15 is an illustration of a wish information record.

FIG. 16 is an illustration of an index of closed information records.

FIG. 17 is an illustration of an index of open information records.

FIG. 18 is an illustration of an inactivity index of information records.

FIG. 19 is an illustration of an index of information records including records created in a specific topic.

FIG. 20 is an illustration of an information record.

FIG. 21 is an illustration of a reply.

FIG. 22 is an illustration of a wish information record.

FIG. 23 is an illustration of an assignment summary screen.

FIG. 24 is an illustration of a creation assignment screen.

FIG. 25 is an illustration of a project summary screen.

FIG. 26 is an illustration of a project text screen.

FIG. 27 is an illustration of an information record.

FIG. 28 is an illustration of a topic specific information record index.

### DETAILED DESCRIPTION

Before one embodiment of the invention is explained in detail, it is to be understood that the invention is not limited in its application to the details of the construction and the arrangements of the components set forth in the following description or illustrated in the drawings. The invention is capable of other embodiments and of being practiced or being carried out in various ways. Also, it is to be understood that the phraseology and terminology used herein is for the purpose of description and should not be regarded as limiting.

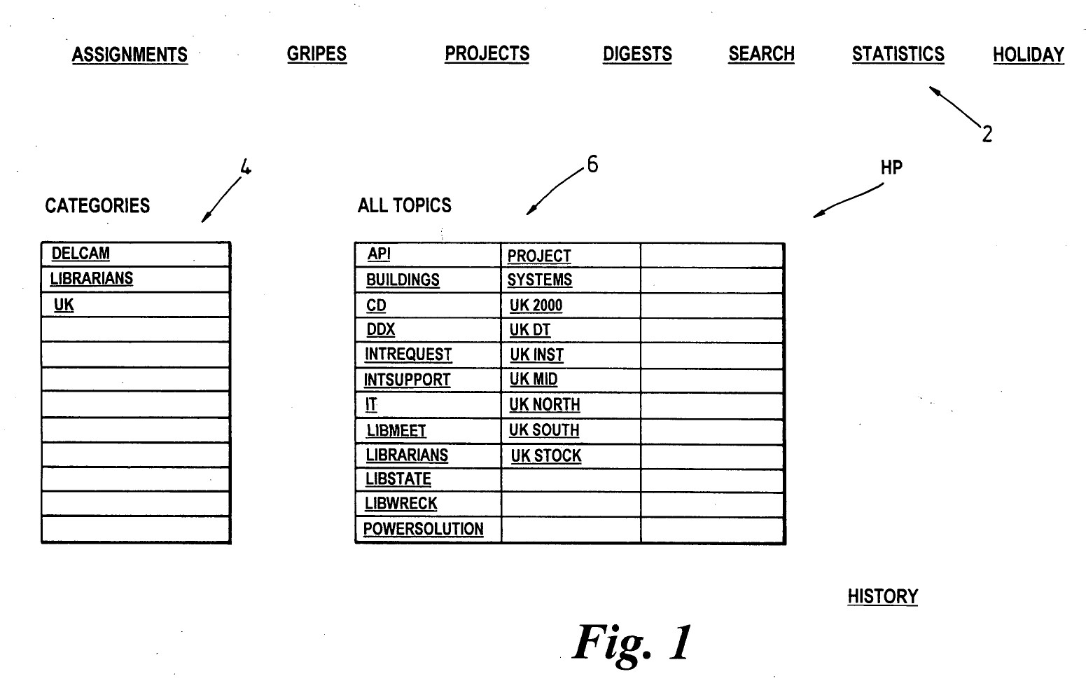

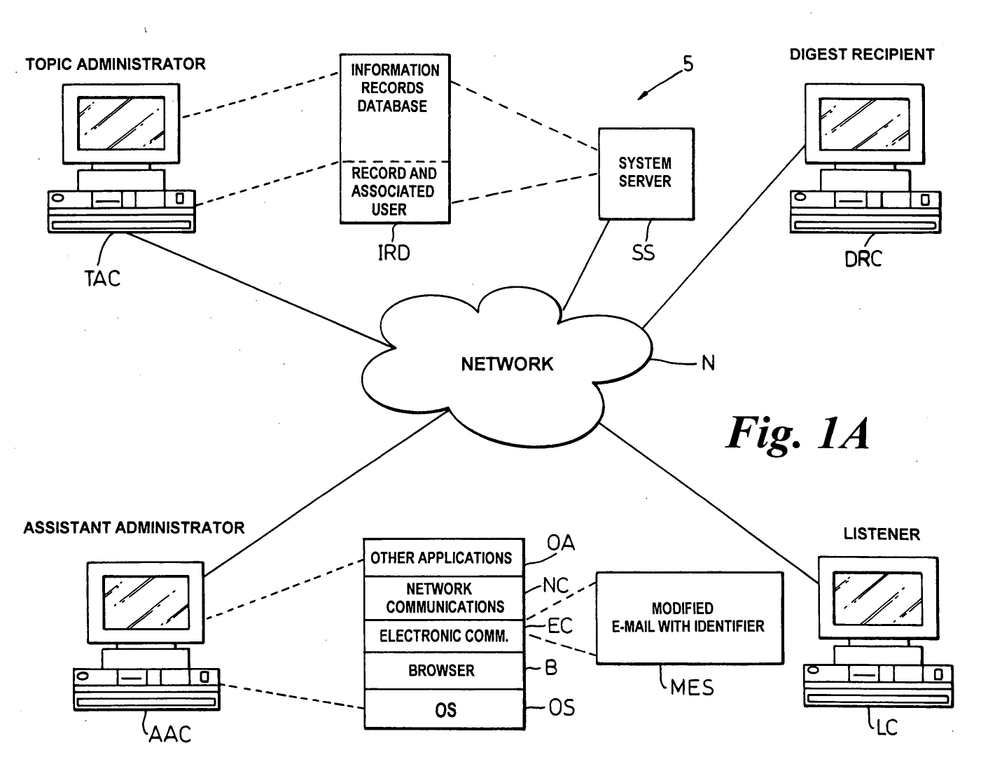

FIG. 1A shows an exemplary system S embodying the invention. The system S includes a network N to which a number of client devices are coupled. The client devices include a topic administrator client TAC, an assistant administrator client AAC, a digest recipient client DRC, and a listeners client LC. The topic administrator client TAC may actually act as both a client and a server. It may contain an information records database IRD with multiple information records associated with users of the system S. Alternatively, a system server SS may be used to store the information records database IRD. Each client includes various software. An example of such software is shown with respect to the assistant administrator client AAC. In the embodiment shown, the client AAC includes an operating system OS; a browser B, an electronic communication module EC, and network communications software NC. The clients also may include other application software OA. Preferably, the electronic communications module EC is a modified e-mail program MES, where communications can be associated with a uniquely identified user.

The software as described herein provides an information management and recording system or, more broadly, an information system. The information system uses available e-mail software and hypertext linking software to manage information provided on the system. Thus, there are two distinct aspects to the system. For ease of reference, it is easier to describe the hypertext link portions of the information system before describing the email-based system.

The information system is password controlled allowing a number of different levels of access to be provided. The system is designed to run across a network and have the users of the network as users of the system. In the embodiment described, the system runs across a network implemented using packet-switching protocols, such as an intranet, but it is possible for users to connect to the intranet remotely, perhaps via a dial-up connection or via the Internet. Such remote users are given restricted access rights when compared to users of the intranet and, for instance, are allowed to see a restricted set of information. (It is, of course, possible for the system to be run on other local area networks (LANs) and wide area networks (WANs) with various topologies and communication protocols.)

The system is designed with a hierarchy of users, which in the exemplary embodiments described includes four levels of users. User access may be controlled, defined, or restricted on a topic basis (users can be given access to some topics, but no access to others). User access may also be defined based on the ability to create and view information. Further, the ability to view information may be restricted according to who authored or created that information. For example, a user can be restricted to creating or opening new information records (sometimes referred to as “Gripes”) on particular topics. A user can be allowed to view only information records that have been assigned to him or her; a user can be allowed to view only records that have been opened by him or her; or a user can be assigned a combination of these restrictions.

Underlined words in the figures represent a link to another part of the system. The hypertext link based portion of the system is operated using a standard browser that is freely available (for example Netscape Navigator™, Microsoft Explorer™, etc.). As such, full use can be made of the forward and back buttons and the history function of the browser to navigate the hypertext links on the various screens of the system.

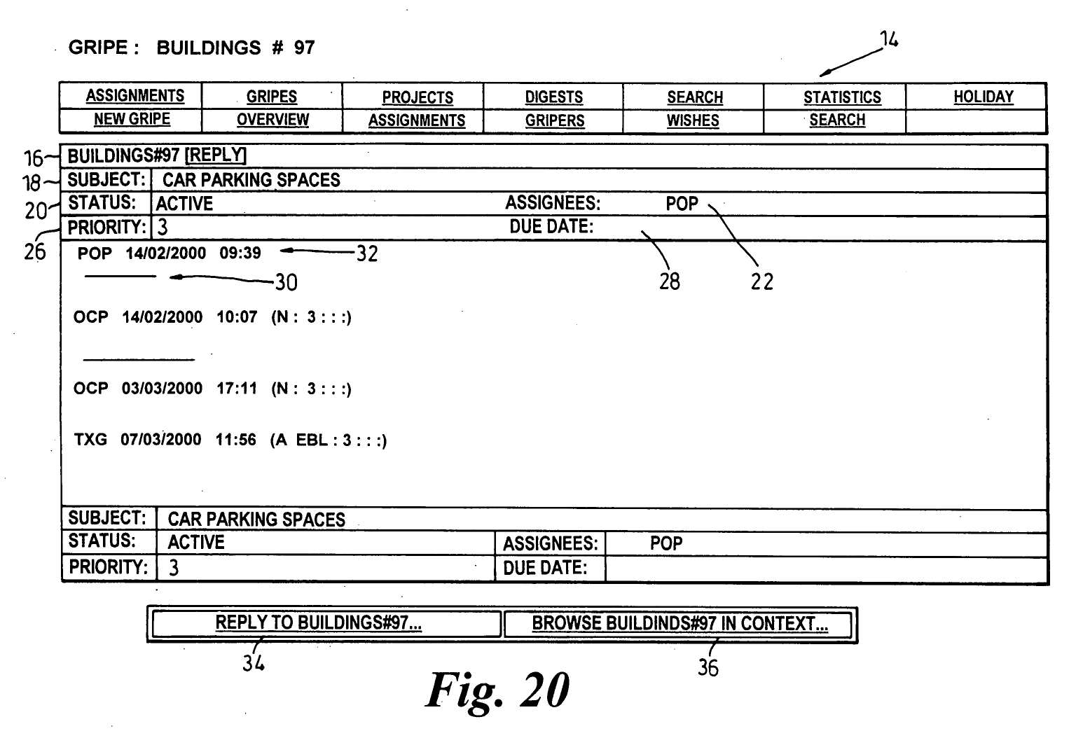

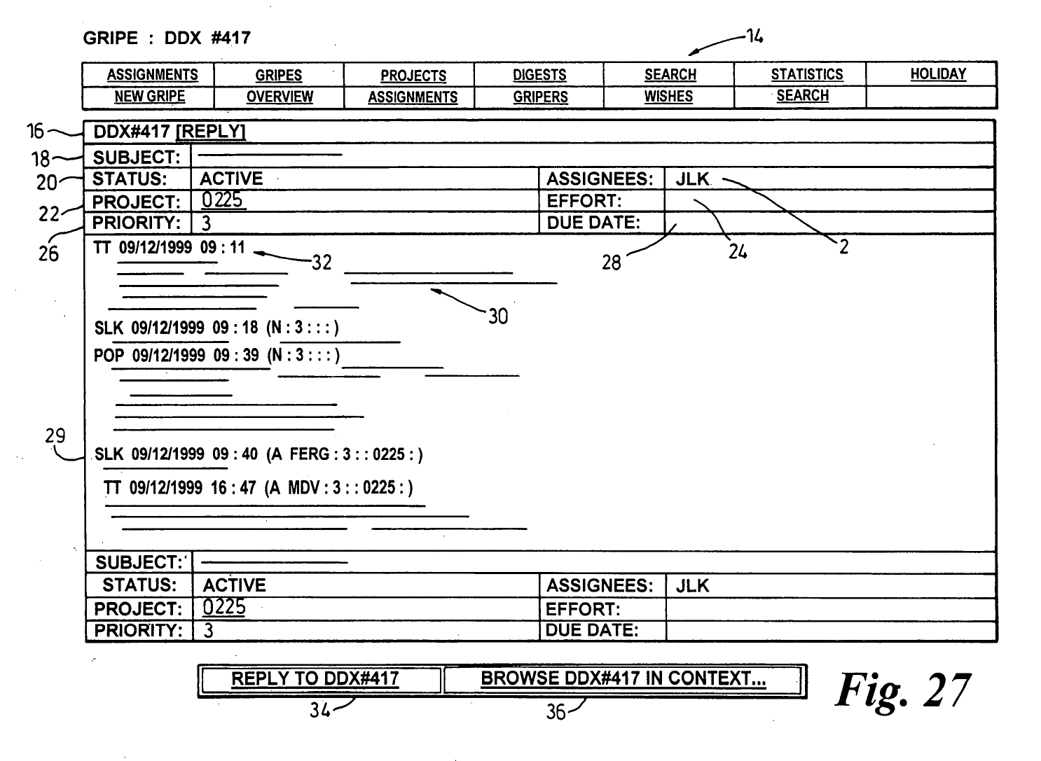

Central to the information system are information records or, as noted above “Gripes.” Examples of how information records are presented are shown in FIGS. 20 and 27. Information records contain content that can be viewed, passed between users of the system, and manipulated in other ways. The information system facilitates the processing of the information records, allowing them to be tracked, created, viewed, searched, and modified. Further, the system records the history of the information within a particular information record.

The components shown in FIGS. 20 and 27 share a common menu bar 14. As will be explained hereinafter, the menu bar provides links to other displays of the system.

To allow the information records to be processed they are categorized in a number of ways. For instance, each information record is placed into a topic, has an index number assigned to it, a creator, and a subject. Further, each topic is placed into a category, and some information records are placed into projects. These terms will be expanded upon hereinafter.

Each information record includes a table holding details of the information record, such details being contained in fields. Comparing FIGS. 20 and 27, it will be seen that some of the fields are optional whereas other fields are common to all information records.

Each information record has a topic field 16 that indicates the topic into which the information record has been placed. Alongside the topic name a unique topic number is provided indicating which information record within the topic is being viewed. These unique topic numbers are assigned to the information record when it is created and consequently a consecutive list of unique topic numbers is created within a topic.

Below the topic field 16 is a subject field 18 that contains a short descriptive title of the subject of the information record. The subject of the information record is also shown at a bottom region of the table.

The next field is the status field 20. The status field 20 indicates the current status of the information record. The status field can take the following values: unassigned (indicating that this is a new information record and has not been assigned to a user), active (indicating that the information record is being progressed), wish (indicating that the contents of the information record are thought to be a good idea, but should be acted on at a later time), closed (indicating that the subject of the information record has been dealt with). Both of the information records shown in FIGS. 20 and 27 are shown as being “Active”.

Each information record also includes an assignee field 22. The assignee field 22 indicates the person that has been assigned management of the information record. As will be explained hereinafter, this can be any one of the registered users of the information system.

FIG. 27 illustrates an information record ddx#417. FIG. 27 includes two fields that FIG. 20 does not have: a project field 22 and an effort field 24. These optional fields are used to provide a meaningful description and a reference number for the information record ddx#417. The information record ddx#417 has been assigned to project number 0225. The effort field 24 is blank, but may be assigned an effort value by a controller of the information record or a topic administrator.

A priority field 26 allows the importance of the information record to be viewed and can take a value of between 1 and 3 (1 being high priority). If the work contained in the information record must be completed by a certain date then a due date field 28 can be completed. Neither of the information records shown in FIGS. 20 or 27 have been assigned a due date.

The main content or text of the information record is contained in a main window 29. The main content of the information record builds up over time as different users add comments, reports of action, and other data to the information record. The main content of the information record is ordered so that the oldest comments appear at the top of the main window 29 and the newest comments are added to the bottom of the window.

When additions are made in text form, each addition to the main content includes a body of text 30 that is headed by an information line 32 containing the initials of the person that created the addition, and the time and the date when the addition was made. Thus, as the information record is added to, a history of the information record is created. This history is beneficial because it creates a record, or audit trail, of how the work covered by the information record was progressed. Therefore, if any queries occur at a later date relating to the progress of the work it is relatively easy to see how the work was progressed.

The audit trail is useful in many circumstances, including debt recovery. In debt recovery, each contact with the debtor can be recorded. Thus, an evidentiary record as to how and what attempts were made to recover the monies owed are readily at hand should such evidence be required at a later date. A further example of where the audit trail is useful is during queries with third parties that request information as to how a query they have made is progressing. It is relatively easy to answer such queries by accessing the information record in relation to the query at which point the third party can have explained to them just what steps have been taken in respect to their query.

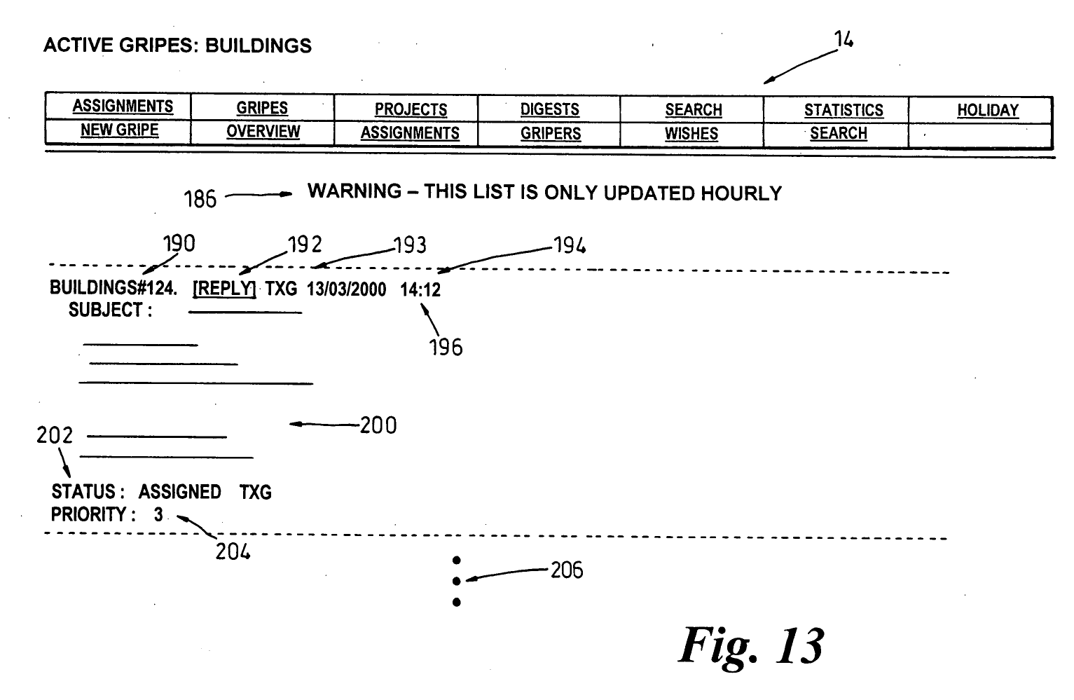

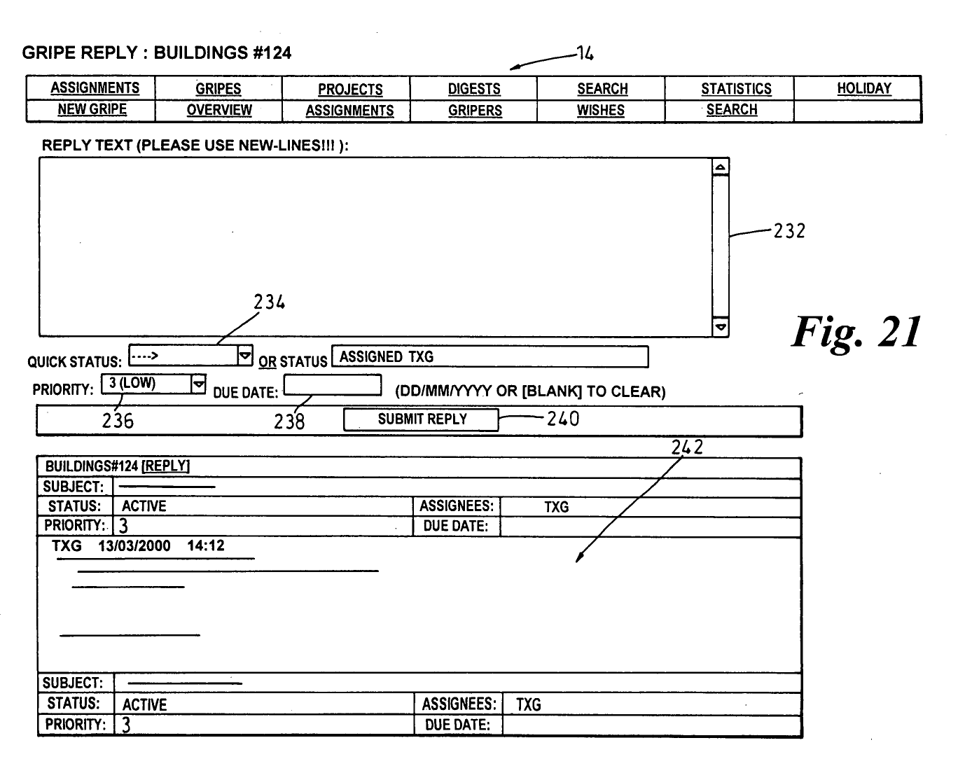

At the bottom of the information record are two links 34 and 36 that allow replies to be made to the information record or to browse the information record in context. Activating the reply link 34 allows a user to make a reply and add a comment to the information record and takes the user to a screen shown in FIG. 21 (which will be described hereinafter). Activating the link 36 takes a user to a screen as shown in FIG. 13 in which each of the information records within a particular topic are listed in numerical order. This allows a user to easily see what else has been occurring in that particular topic. This feature may help to prevent the duplication of work; if a user can see what is already being worked upon they may be prevented from creating new information records on similar or identical issues. This screen will be described in more detail hereinafter.

Before describing the features of the system that allow the information records to be processed, it is necessary to explain the different classes of users within the information system. The classes of users have different access rights in relation to the information records. It will be appreciated that not every user of the information system will be interested in every information record. Indeed, some of the information records may relate to sensitive information to which only some of the users should be allowed access.

In the embodiments described, the information system has four different classes of users: topic administrators, assistant administrators, passive participants, and digest recipients. Different users may have different statuses in relation to different information records; different topics (and information records within those topics) are likely to have varying levels of interest for different users.

A digest recipient receives summaries of changes to a particular topic rather than the complete change to the topic as is sent to passive participants.

A passive participant is a user that has registered an interest with a particular topic and who thereafter receives all updates to that topic. (It should be noted that the topic administrator can restrict the topic so that only assistant administrators receive topic updates).

An assistant administrator is a full user of a topic and has all the rights of a passive participant plus the right to open new information records, reply to information records, change the information record status and/or assignments, change priority and/or due date (when enabled), change project details (i.e., the project number and effort estimates), change the information record subject (perhaps to make it more meaningful). (The topic administrator can set (or upgrade) a particular topic so that any user of the system can open new information records, reply to information records, and change the information record status and/or assignments within that information record. This feature is useful for topics that have general effect on the users of the system).

A topic administrator is the manager of the topic and has all the rights of an assistant administrator plus the ability to add and/or remove assistant administrators and/or passive participants, upgrade the topic (as discussed above in relation to passive participants and assistant administrators), enable and disable priorities and due dates for that topic, enable and disable project management (i.e., allow project numbers and effort estimates to be assigned to information records in the topic), restrict listening to assistant administrators only, restrict topic access to assistant administrators only, set the home page (as will be explained hereinafter), assign unassigned information records, and assign estimates of the amount of work in a particular information record.

Generally, any user of the system can sign up as a passive participant or a digest recipient, but some topics may be closed. Sign up to a closed topic requires the approval of the topic administrator for that topic. The approval of the topic administrator must be sought for any user to sign up as an assistant administrator.

The hypertext link based portion of the information system includes a number of interactive forms or pages that preferably take the form of a home page and one or more additional pages. FIG. 1 illustrates a home page HP with a number of links to information of interest to the users of the system.

Along the top edge portion 2 of the home page HP there are seven links: ASSIGNMENTS, GRIPES, PROJECTS, DIGESTS, SEARCH, STATISTICS, and HOLIDAY. (It will be seen that these seven links are the same as those that appear on the top line of the menu bar 14 in FIGS. 20 and 27). There are two tables 4 and 6 in the center of the home page HP. The tables contain links to various further displays as will be explained hereinafter.

The table 4 is a category list and contains a list of categories into which topics can be placed. Each category has a meaningful title that gives an indication as to what the topics placed therein relate. Selecting a link in the table 4 displays a list of topics held in that category.

The second tables 6 is a topic list and contains a list of all of the topics within the information system. The topic title gives an indication of the contents of the information records within the topic. In contrast to the list in table 6, table 4 provides a sub list of topics, which is easy to navigate when the user knows the exact category of interest to him or her.

In the bottom right hand corner of the home page HP is a HISTORY link that connects to a revisions page having revisions to the information management system. This allows the user to see how the system has recently been modified.

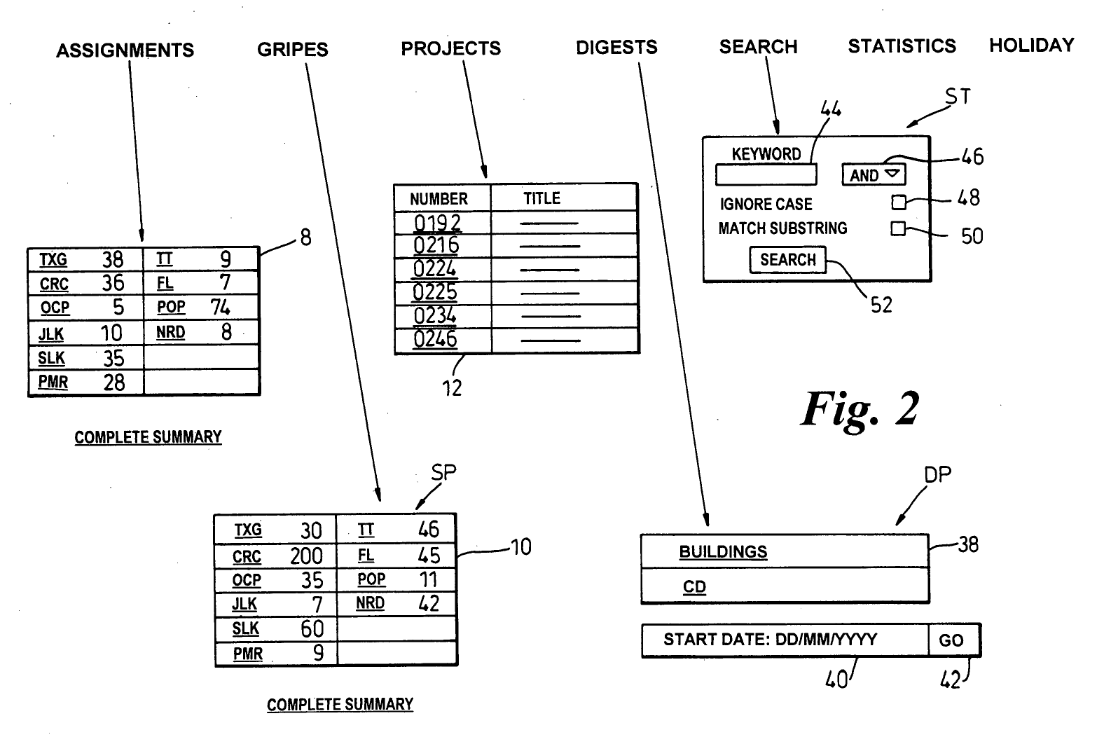

Users of the information management system must be registered with the system and each user is assigned a unique identifier. In the embodiments described, the identifier is based upon the user's initials. Activating the ASSIGNMENTS link on the home page HP displays an assignments page AP, as shown in FIG. 2. Alternatively, the assignments page AP and the additional pages described below may take the form of pop-up dialog boxes. The assignments page AP includes a table 8 listing the identifiers of all of the users of the system. Each identifier is itself a link to an additional page (discussed below).

Each information record can be assigned to a particular user to action. That is, the assigned user is given responsibility for that information record. The number of information records that have been assigned to each user is shown in the table 8 (assignments table). The number of assignments gives an indication of the workload of each user.

Activating the INFORMATION RECORDS link on the home page HP displays a third summary page SP, also shown in FIG. 2. The summary page SP includes an information records table 10 containing all of the users of the system with the number of information records that each particular user has created. Again, each of the identifiers within the information records table 10 is itself a link to an additional page.

Activating the PROJECTS link on the home page HP displays a projects table 12, also shown in FIG. 2. The projects table 12 includes a list of project reference numbers, each of which is itself a link, together with the descriptive title of the project.

The D_{IGEST} link on the home page HP connects to a digests page DP that includes a table 38. The table 38 lists the topics for which the user viewing the screen receives digests. (It will be appreciated that a particular user will log onto the information system and that therefore the system will be aware of the identity of the user). In the digest table shown, there are two topics listed (buildings and CD) for which digests are provided.

The digest page DP also includes a start date box 40 having associated therewith a start date, which can be edited by the user, and a “Go” button 42. When a user activates a link to a topic (i.e., buildings and CD in this case) a list of digests for the selected topic is displayed. If a user presses the Go button 42, only those digests having a date on or after the start date in the start date box 40 are displayed.

The SEARCH link on the home page HP connects to a search tool ST, shown in FIG. 2. The search tool ST provides an interface for searching the information records within the system. A text-input box 44 is provided allowing keywords to be entered. A drop down box 46 is provided allowing logical operators to be used in the search. Further, a check box 48 is provided allowing the user to specify that the search engine should ignore the case of the search terms. A second check box 50 allows the user to specify whether the string being searched for can occur in a sub string or not. Finally, a search button 52 is provided allowing the user to start the specified search.

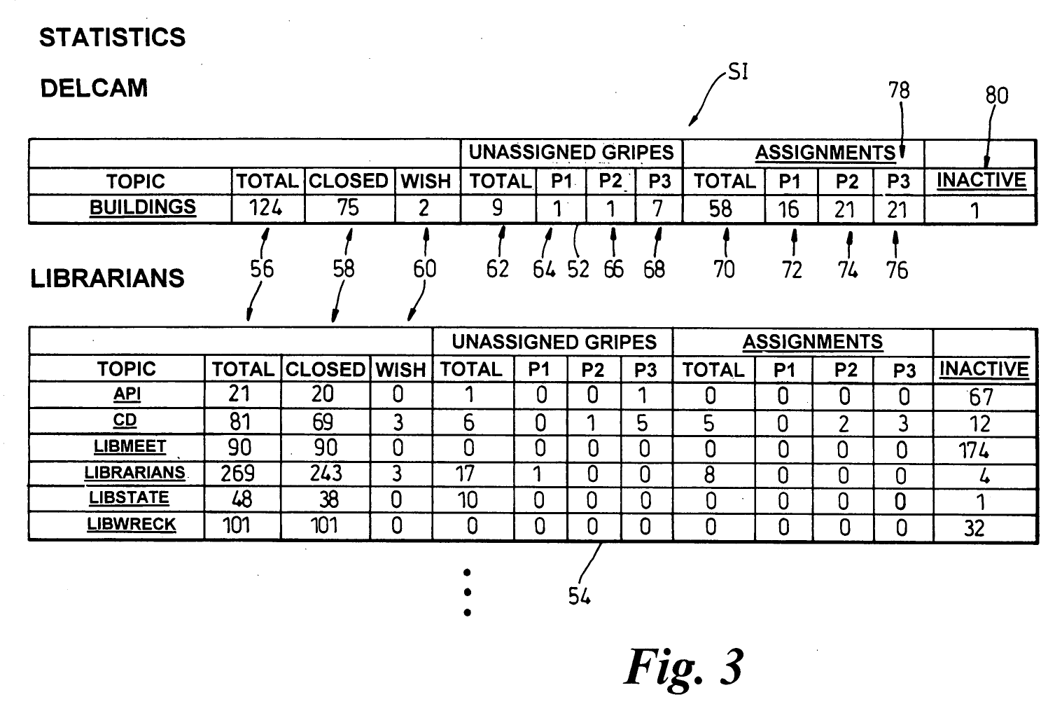

The STATISTICS link on the home page HP connects to a summary information page SI, an example of which is shown in FIG. 3. Although only two topics are shown in FIG. 3, all of the topics in the system are summarized by activating the STATISTICS link. The user can scroll down the screen using the vertical scroll bar in order to see the remaining topics.

A separate table is presented for each category and in FIG. 3 tables have been shown for a delcam category 52 and a librarian category 54. Except for the title row, each row represents a separate topic within a category. It will be seen that the delcam category 52 only has a building topic, whereas the librarians category has an api, cd, libmeet, librarians, libstate, and libwreck topics.

The columns of the tables summarise different aspects of the topic to which they refer. A first column 56 shows the total number of information records that have been created in that particular topic. A column 58 indicates the number of information records that have been finished, or closed, within that particular topic, and a column 60 indicates information records that have a wish status.

A summary of the unassigned information records is provided in four columns 62, 64, 66, and 68. The summary includes the total number of information records that are not assigned to a user, and then the information records having priority one, priority two, and priority three statuses. Following the summary of the unassigned information records are four columns 70, 72, 74, and 76 that summarize the assigned information records. The summary includes the total number of assigned records and the number of priority one, priority two, and priority three records.

Following the summary of the assigned information records there is a column 80 labelled “Inactive”. The Inactive column shows the number of days since the last modification of any information record in that particular topic. When an information record within that topic is modified the counter is reset to zero.

As with the remainder of the system, various hypertext links exist on the SI page and these are shown underlined. An Assignments link 78 and an inactive link 80 connect to warnings at the bottom of the page. These warnings inform the user that the information record assignments field specifies the number of individual information record assignments and, therefore, an information record assigned to two people counts as two assignments. It is for this reason that totals of the wishes, closed, unassigned, and assigned information records do not equal the total number of information records within a topic.

The warning relating to inactive information records informs the user that the inactive field specifies the number of days since the last modification of any information record within the topic, as explained hereinbefore.

Activating a link associated with any of the topic titles takes the user to a topic overview screen.

The last of the seven links on the home page HP is the HOLIDAY link. The HOLIDAY link connects to a page (not shown) that allows a user to suspend the mail aspect of the system (described hereinafter) when they are on holiday.

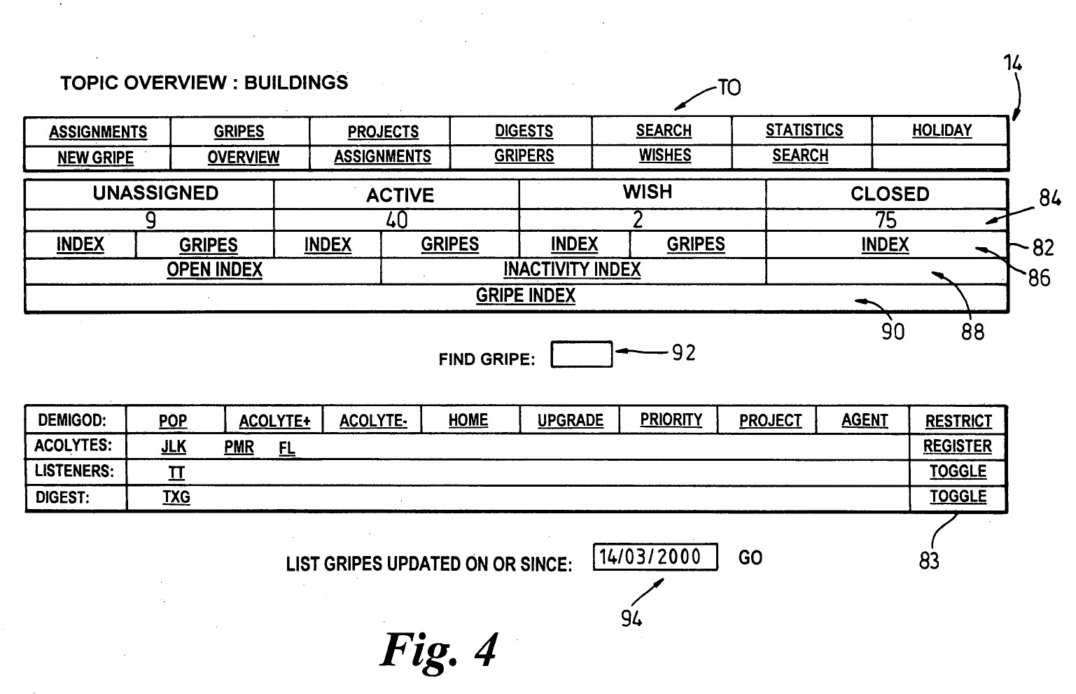

FIG. 4 shows a topic overview or summary page TO for a buildings topic. The summary page can be reached from any link to the buildings topic (i.e., an underlined word “buildings”). Such links to the buildings topic occur on the statistics page SI (FIG. 3), and in the topics table 6 of the home page HP.

The page TO includes the menu bar 14. The menu bar 14 is common to many screens in the information management system and allows a user to reach a number of key screens within the system. The page TO includes a building information record summary table 82, and a building information record user summary table 83. The building information record summary table 82 provides a summary of the number of information records in various categories that is different from the summary information contained in the table 52 on the statistics page SI shown in FIG. 3. The building information record summary table 82 shows the number of information records within each of the four information record statuses (unassigned, active, wishes, and closed) in this particular topic (the building topic). In this example, there are nine unassigned (new information records), forty active information records, two information records having a wish status, and seventy-five closed information records. These statuses are provided in a summary row 84.

The building information record summary table 82 includes a plurality of links in a row 86. The links in row 86 connect to indexes for and the text of the information records having the four statuses. Specifically, a link to an index and the information record text is provided for each of the statuses unassigned, active, and wish. For information records having a closed status there is only a link to an index. In sum, depending on the information record and its status there may be an unassigned index link, an active gripe index link, a wish gripes index, a closed gripes index link, an unassigned gripes link, an active gripes link, and a wish gripes link.

Below row 86 is a links row 88 containing two further links. A first of these links goes to an index of open information records, and a second goes to an index of information records indexed according to the last time the particular information records were modified (an inactivity index). Finally, a further links row 90 provides a link to an index of all of the information records within the buildings topic referred to as “the information record index.” The building information record user summary table 83 provides the identity of the topic administrator of the topic, the identity of the assistant administrators and passive participants, together with the identities of any digest recipients. Also provided are a number of links to screens that allow the assistant administrators, passive participants, and digest recipients lists to be modified and other information relative to the topic to be modified. The following links are provided: assistant administrator, assistant administrator-, Home, Upgrade, Priority, Project, Agent, Restrict, Register, Toggle (associated with passive participants), and Toggle (associated with digest recipients).

Many of the links on the building information record user summary table 83 can only be activated by the topic administrator in order that control of the topic is maintained. The assistant administrator link can only be activated by the topic administrator and allows an assistant administrator to be added to the topic. Likewise, the assistant administrator-link allows the topic administrator to remove an assistant administrator from the topic.

The topic administrator can set the home page that is achieved using the Home link. This feature is useful if screens of information exist elsewhere on the network that may be useful for users accessing that topic. In such circumstances the user can set the home page so that if a home page link is activated the user is taken to these information pages.

The Upgrade link allows the topic administrator to upgrade the topic so that any user of the system can open new information records, reply to information records, or change the information record status and/or assignments.

The Priority link allows the priority feature to be enabled and allows priorities to be assigned to the various information records within the topic. The priority feature can also be disabled.

The Project link allows the project management mode to be enabled or disabled. When a project management mode is enabled, the topic administrator and assistant administrators of the topic are able to link an information record to a project number, and add effort estimates. The setting of priorities and due dates is restricted to the topic administrator and assistant administrators only.

The Restrict link allows the topic administrator to restrict the topic so that only assistant administrators are sent updates to the topic (effectively restricting listener status to assistant administrators only).

The Register link allows the user of the system to register as an assistant administrator and thus, submit and reply to information records from the buildings topic. However, a user application to register as an assistant administrator is vetted by the topic administrator. When a user activates the Register link an e-mail is sent to the topic administrator announcing activation of the link and which user activated that link. For the user to be registered as an assistant administrator the topic administrator must activate the assistant administrator link, in which case the user requesting assistant administrator status is added as an assistant administrator to that topic. When the topic administrator activates the assistant administrator link an e-mail is generated by the system notifying the user that they have been given assistant administrator status.

The toggle link associated with passive participant status allows a user to toggle their status as a passive participant. If the user is a passive participant, activating this link will remove the user as a passive participant whilst if the user is not a passive participant activating this link will add the user as a passive participant. The digest toggle link works in the same manner as the passive participant toggle link, but adds or removes the user from the list of users that receive digests. As noted previously, most topics allow any user to sign up as a passive participant or digest recipient, although some topics are closed and require topic administrator approval for new passive participants and digest recipients.

The TO page also includes a find information record search facility 92. The search facility 92 allows a user to input the unique sequential number assigned to a particular information record that they wish to view. After a user enters a number and hits return they are shown the text of the information record in which they are interested.

A date search facility 94 allows a user to review all information records that have been modified after a particular date. The user is presented with a text box, into which they can enter a date in the dd/mm/yyyy format, together with a button marked “Go.” A user enters the date after which they wish to see information records that have been modified and presses the Go button, after which they are taken to a screen listing details of information records that have been modified in the relevant time period.

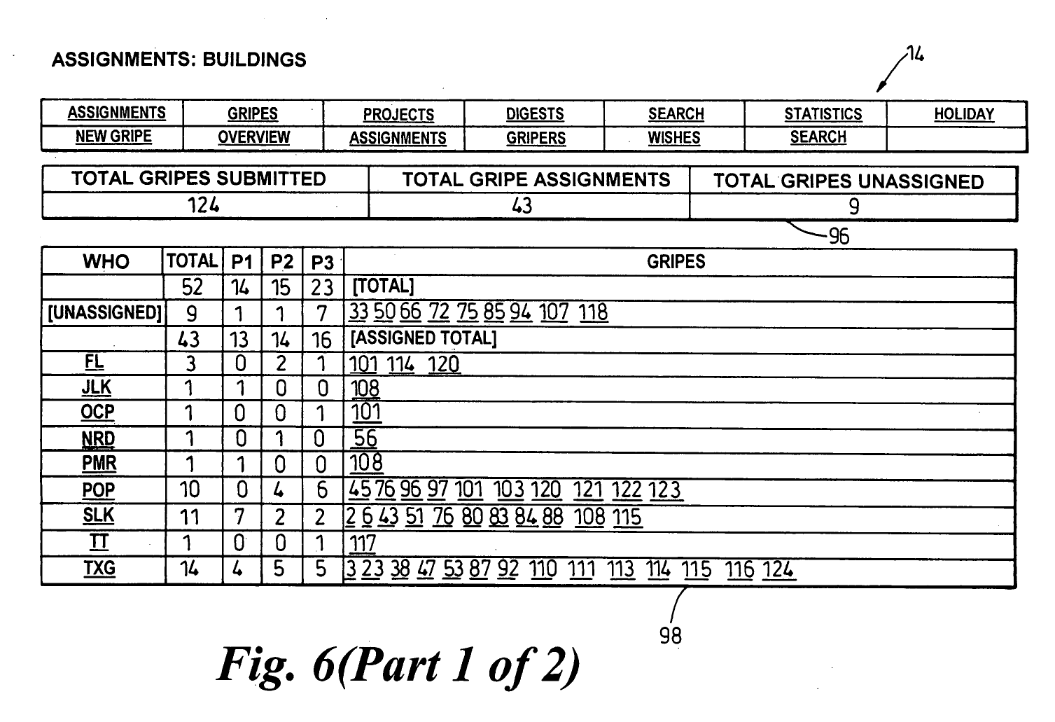

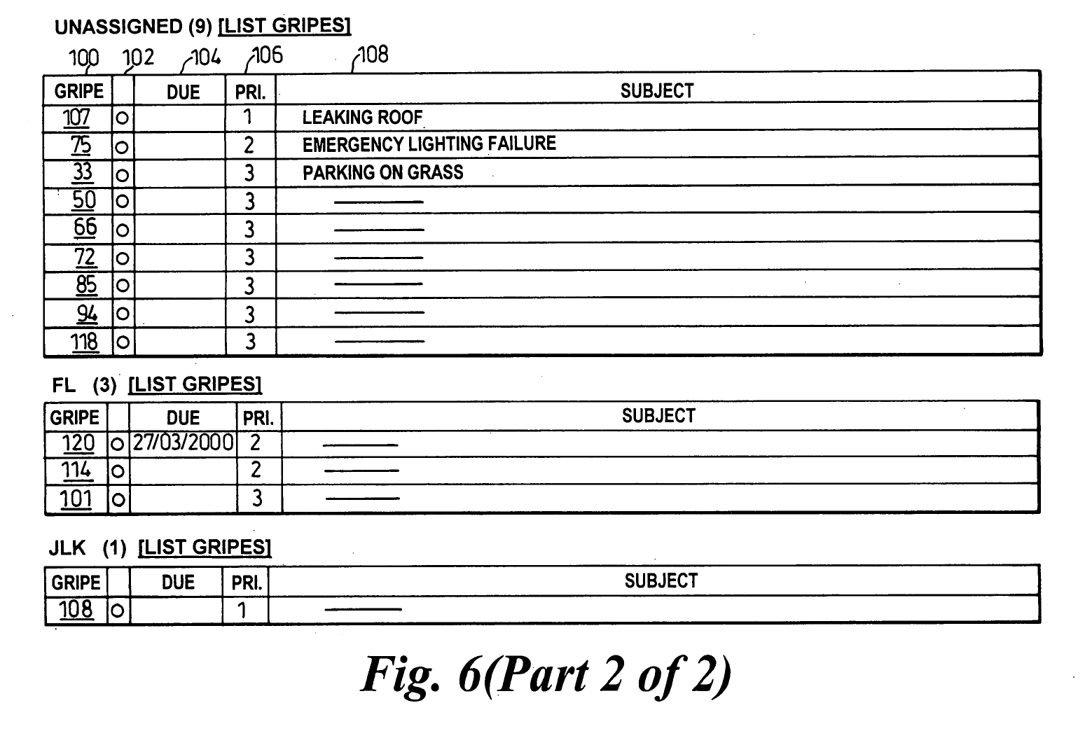

The next link on the menu bar 14 is the Assignments link. The Assignments link connects a user to a list showing all of the information record assignments within the selected topic. An example of such a screen is shown in FIG. 6. The standard menu bar 14 is provided at a top region of the screen which is followed by a summary table 96 which shows the number of information records within the topic (124 in the buildings example), the total number of information records that have been assigned (43 in the buildings example) and the total of new, or unassigned information records (9 in buildings example). The assigned and unassigned information records do not add to the total number of information records in the topic because these figures do not take into account the closed information records.

Following the summary table 96 is a user table 98 listing all the users of the system that have an information record contained in the building topic assigned to them. The left-hand column of this table contains a list of the all the relevant users (each initial acts as a link to the table for that individual user, as is explained hereinafter). A row of the user table 98 is assigned to each user, together with a row for unassigned information records. The next four columns respectively contain the total of information records assigned to that particular user, and then the number of priority one, priority two and priority three information records (the three priorities total the total number of information records for that user). The final column of the table 98 contains the unique sequential numbers of all of the information records assigned to the user represented by that particular row of the table 98 (there is also a row dedicated to the unassigned information records).

Taking one row of the table 98 as an example, a user FL has three information records assigned, two of these are priority two and the third is priority three. User FL has no priority one information records assigned. The final column lists the numbers 101, 114, and 120, which are the unique sequential numbers for the information records assigned to user FL. Each of the sequential numbers listed in the table 98 acts as a link to the text of the information record in question (as illustrated in FIGS. 20 and 27).

After the table 98 is a table for each of the users having a building information record assigned to them showing more detailed summary information than is available in table 98. Activating a link in the table 98 associated with a user's initials takes the user of the system to this more detailed summary table for that particular user. It would also be possible to view the relevant, more detailed, table by scrolling down the screen to the relevant table since the tables are provided, one after another, on a single screen.

The first such summary table is for the information records within the buildings topic that have been unassigned. This table and all of the others show the same basic information for each of the information records that have been assigned to that particular user (or are unassigned). A new row is provided for each of the information records and there are five columns each providing information about that information record.

A first column 100 contains a sequential number for the information record detailed in that particular row. Each sequential number acts as a link to the text of that particular information record (as detailed in FIGS. 20 and 27). A next column 102 contains a graphical symbol, which if activated allows a reply to be made to that particular information record. Next is a due date column 104 showing any due date that has been assigned to the information record; i.e., a date by which the work detailed in the information record must be completed. Next is column 106 showing the priority of the information record. It should be noted that the information records are ordered in order of priority with the priority one information records at the top of each table and the priority three information records at the bottom of each table. The final column of the each table contains the subject of each information record, briefly describing the contents of the information record.

Above each table is a “List Gripes” or list information records link, which if activated causes a listing of all the information records, including the text, detailed in the following table.

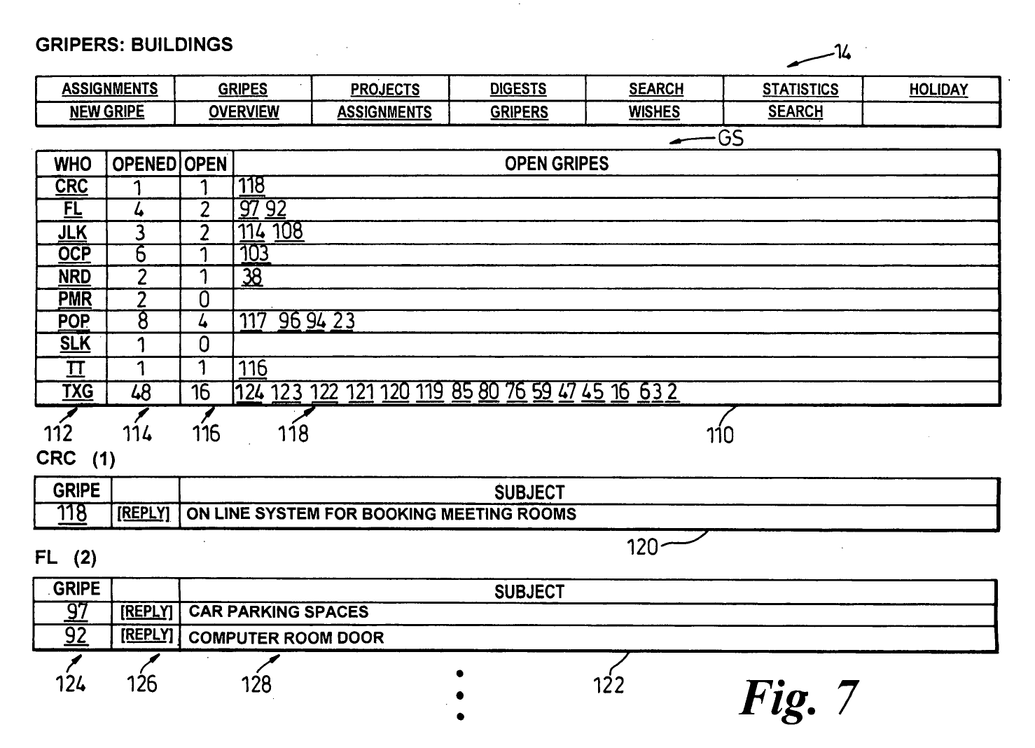

Returning to the menu bar 14, the “Gripes” or information records link takes the user to a gripes screen GS shown in FIG. 7. The gripes screen GS is somewhat similar to the information displayed in FIG. 6, but shows the information records that have been created by the users listed. The gripes screen GS includes a first table 110. The first table 110 contains a list of all of the users that have created gripes or information records in this particular topic. The users initials are presented in a column 112 and act as a link to a summary for that particular user that is presented in a table lower on the screen.

A column 114 details how many information records that particular user has created, or opened. A column 116 shows how many information records are still open. A final column 11 8 provides the unique sequential number for each of the information records that are still open. Again, each of the sequential numbers acts as link to the text of that particular information record.

Following the table 110 are tables 120 and 122 for each of the users that have created an information record within the building topic. The link from each of the users initials in the table 110 takes the user to the table 120 or 122, as appropriate. Each of tables 120 and 122 has three columns: a column 124 showing the unique sequential number for each information record (which acts as a link to the information record text), a column 126 acting as a link allowing a user to make a reply to the particular link, and a column 128 showing a descriptive title for each of the information records.

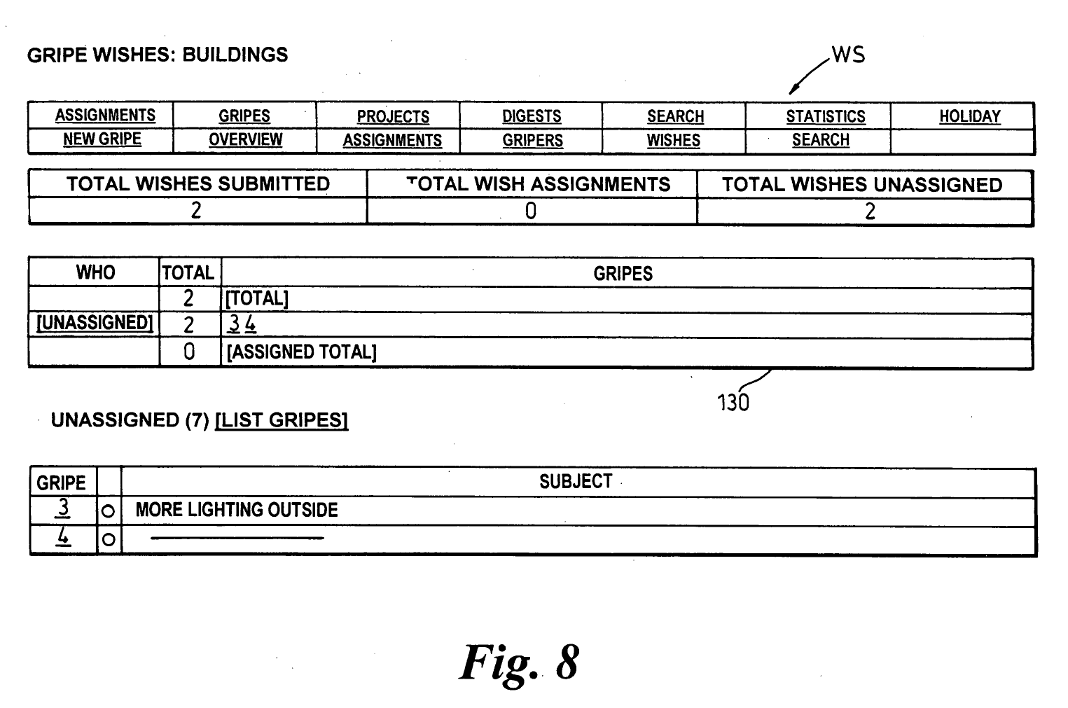

Returning to the menu bar 14 the Wishes link takes a user to a wish screen WS including a table 130, as shown in FIG. 8. The wish screen WS presents a summary screen similar to that shown in FIG. 7, but detailing the information records with a wish status. In this example, none of the information records have been assigned to a user and so no user initials are listed in the table 130. Therefore, both of the building information records having a wish status are listed in the row of unassigned information records. As with the screens shown in FIGS. 6 and 7 each of the unique sequential numbers acts as a link and takes the user to the summary text for that particular information record.

The unassigned label in the right-hand most column acts as a link taking the user to a summary table further down the screen for the unassigned wishes. If any of the wishes are assigned, the user's initials to which it has been assigned are provided in the right-hand most column, and each acts as a link to the relevant summary table further down the screen.

A summary table ST for the unassigned wishes for the buildings topic is also shown in FIG. 8. The summary table ST has three columns: a first having the unique sequential information record number (which acts as a link to the information record text), a second with a graphical symbol acting as a link to a reply page, and a third column containing information showing the subject of the information record.

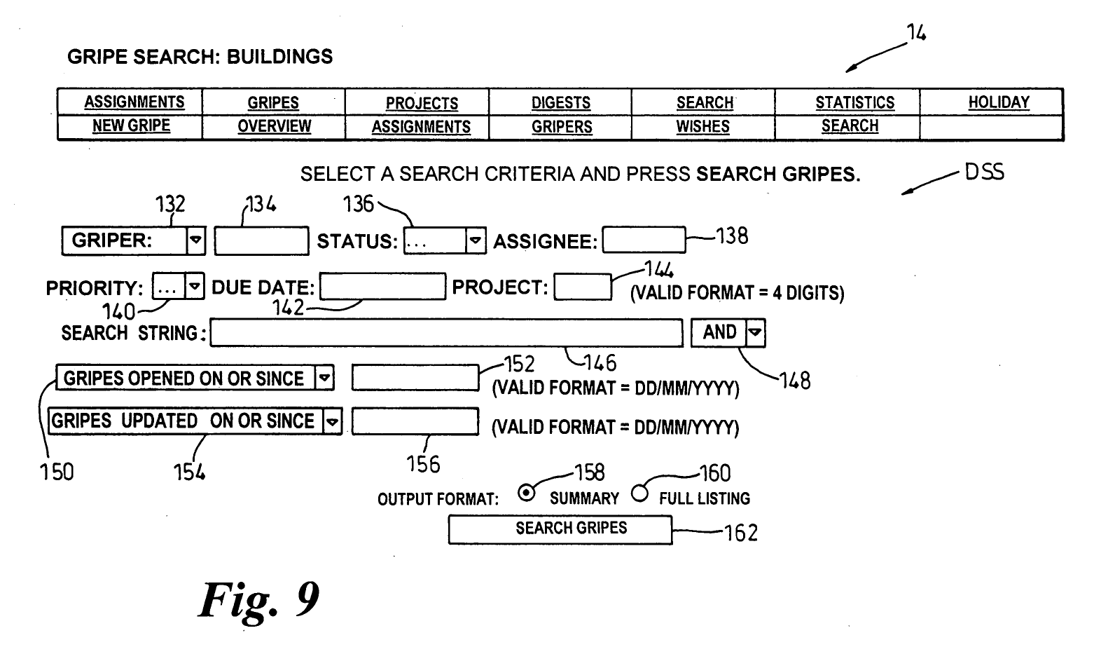

Returning to the menu bar 14 a Search link, on the lower row, takes the user to a dedicated search screen DSS for the buildings topic (or the topic that is being viewed by the user at the time). It will be appreciated that the top row of the menu bar 14 is a global menu, whereas the lower row is specific to a particular topic. The dedicated search screen DSS is shown in FIG. 9. As usual, the menu bar 14 is provided at a top region of that screen.

The dedicated search screen DSS, includes a number of drop down boxes, text input boxes, check boxes, and buttons that allow a user to tailor a search as desired. A first drop down box 132 is associated with a text input box 134. The text input box 134 allows a user to enter initials that will be searched against the users of the system. The first drop down box 132 allows the user to specify whether the information record should be searched using the initials in box 134 to specify an information record created by the specified user or whether that user has contributed to the information record rather than having created it.

A status drop down box 136 is provided that allows a user to specify the status of the searched for information record or information records. The drop down box 136 has the following options: new, active, wish, open, and closed.

An assignee text input box 138 is provided allowing the user to enter and, therefore, specify the initials of the user that the searched for information record should have.

A priority drop down box 140 having the options 1, 2, and 3 is provided allowing the priority of the searched for information record to be specified. A search string text input box 142 allows the user to specify a due date. A text box 144 allows a project number to be specified. A text box 146 allows a search string to be entered that is then searched for in the body of the information record text. If more than a single term is entered into the search string text input box 146 the user can specify whether these terms are combined using the logical operators AND or OR using a drop down box 148.

A further information record opened, drop down box 150 is provided in association with an information record opened, text input box 152. The information record opened text input box 152 allows the user to specify a date in the format dd/mm/yyyy. The information record opened drop down box 150 allows the user to specify whether information records should be searched for that have been opened on or since the date or before the date specified in the information record opened text input box 152.

Similarly, there is provided an information record updated drop down box 154 allowing a user to specify whether a date entered into the information record updated text input box should be used to search for information records that have been opened on or since the date or before the date. Two check boxes 158 and 160 allow the user to specify the type of output they require: a summary, or a full listing. Selecting one of these boxes 158 or 160 deselects the other. Button 162, when activated, carries out the search specified on the remainder of the screen.

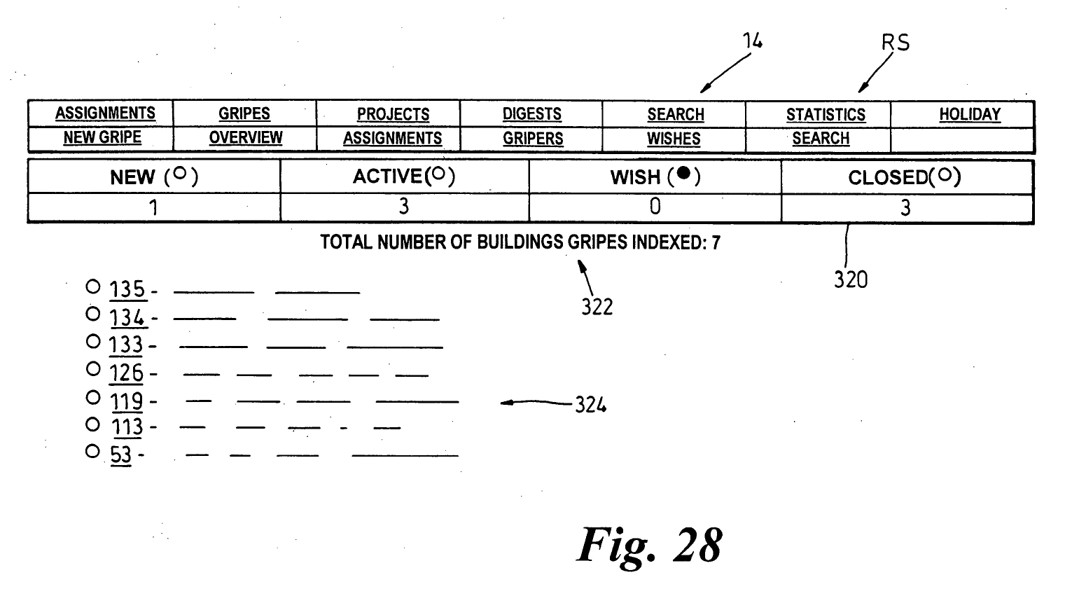

Performing a search using this screen takes the user to a results screen RS, as illustrated in FIG. 28. The results screen RS includes the menu bar 14 at a top region thereof, a results summary box 320, a summary statement 322, and a list 324 of information records that were hits of the search.

The results summary box 324 shows the number of information records that the search has located in each of the four information record status categories (new, active, wish, and closed). In the example results screen of FIG. 28, the search has located one new information record, three active information records, zero wish information records, and three closed information records: seven information records in total.

The summary statement 322 reflects that seven information records have met the search criteria and the list 324 provides a colored icon (corresponding to the information record status), the unique sequential number of the information record within the topic and the descriptive title of the information record. Each of the unique sequential numbers acts as a link and takes the user to a screen having the information record text thereof (examples are shown in FIGS. 20 and 27).

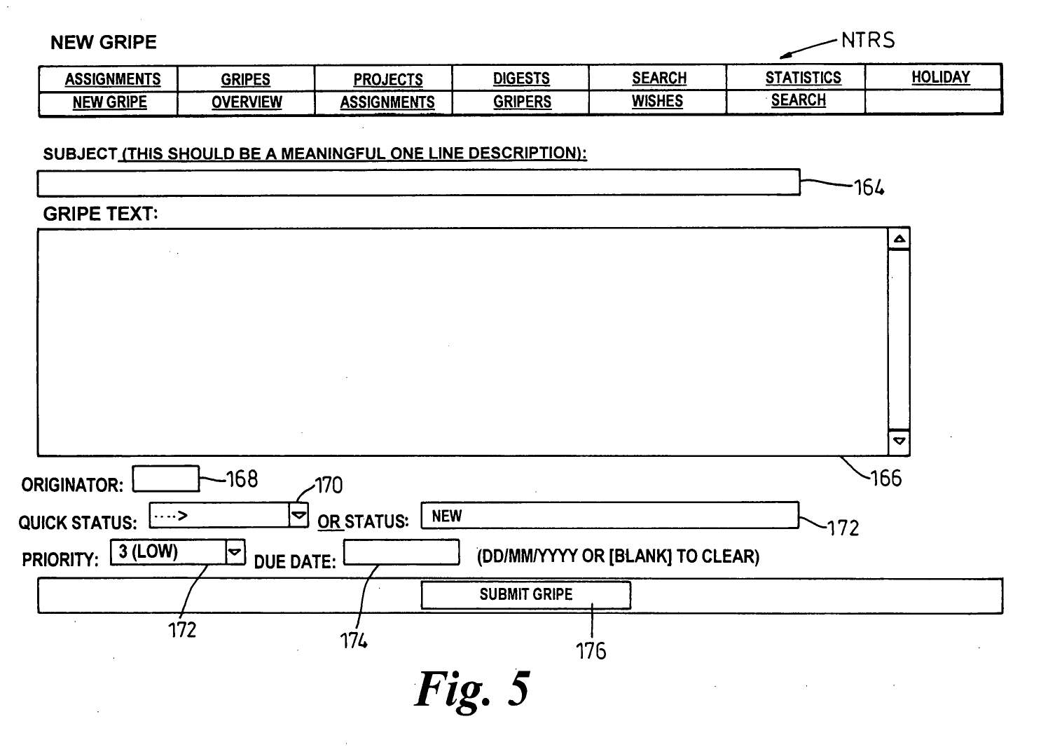

Returning to the menu bar 14, the “New Gripe” link connects to a new information record screen NIRS, shown in FIG. 5. The new information screen allows authorised users to create new information records within a topic. Generally, only the topic administrator and assistant administrators of a topic can create new information records, but any user can create information records if the topic has been upgraded to allow this (as discussed above). The new information record screen NIRS includes a subject text box 164 into which a short descriptive title can be provided for the new information record. A much larger information record text box 166 having a vertical scroll bar is provided to permit a user to enter the text of the new information record.

The new information record screen NIRS also includes an originator text box 168 to provide input for a user's initials. A quick status drop down box 170 allows the user to quickly specify the status of the new information record (new, closed, assigned, followed by initials of a possible users, or wish followed by the initials of possible users). The statuses are more completely described herein below. If the user does not use the quick status drop down box 170 to specify the status, the system provides a default status “new,” as is indicated in a text box 172. If the new information record is left to default to status “new,” then it appears on the various screens of the system as unassigned. It should be noted that unassigned information records are often provided with separate tables and appear at the top of others making them readily apparent. Further, it should be noted that the topic administrator will be sent any newly created information record so that they will appreciate that an unassigned information record has been created. The onus is on the topic administrator to monitor such unassigned information records and act on them accordingly, which may involve assigning them to a user to act upon.

A priority drop down box 172 is provided to allow the user to specify whether the new information record is priority one, two, or three. A due date text input box 174 accepts a due date for the new information record in the format DD/MM/YYYY.

A submit information record button 176 is provided to allow a user to submit the new information record to the system. Once the submit button has been pressed the new information record is submitted to the system and a screen is displayed to the user indicating that the information record has been submitted and showing the number that has been assigned to the information record.

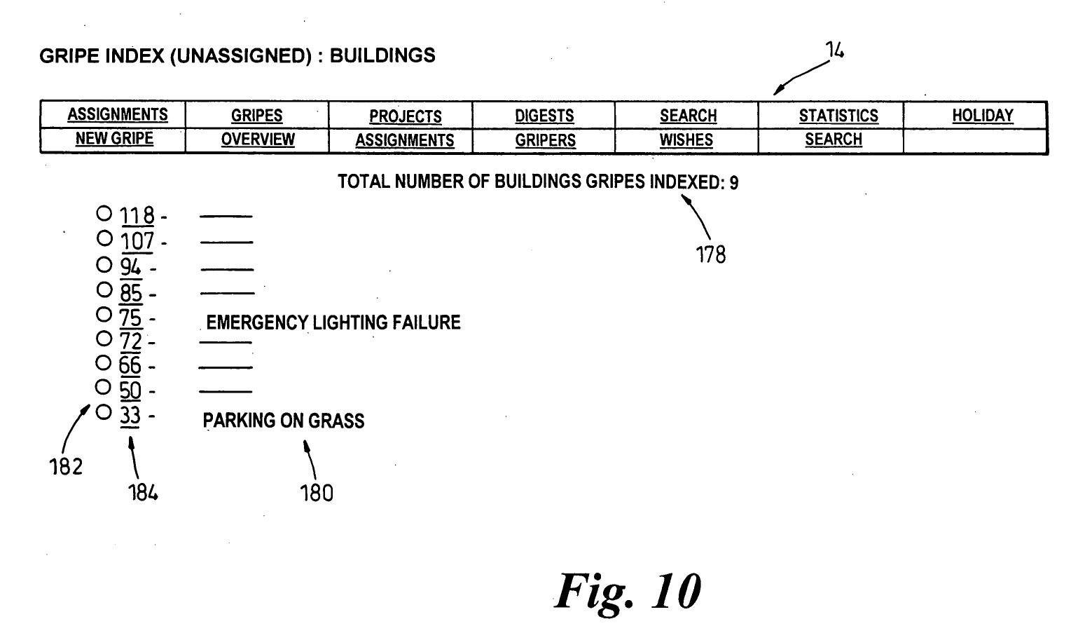

The links from the topic overview page TO will now be explained. The unassigned index link takes the user to an index screen IS shown in FIG. 10. The IS screen has at the top region thereof, the menu bar 14. Below the menu bar is a statement 178 as to how many information records appear in the index. In this example, nine information records are indexed. The screen IS also includes a list of information records 180 that includes, at the left-hand most edge, a column of circular icons 182. These icons act as links to a reply screen and allow the user to make a reply to the information record associated with that icon.

Next to the icons 182 is a column 184 of the unique sequential numbers for the information records that appear within the index (i.e., topics that are unassigned within the buildings topic). Again, each of these sequential numbers acts as a link to the text of that particular information record. Beside each sequential number, the descriptive title of each of the information records is provided.

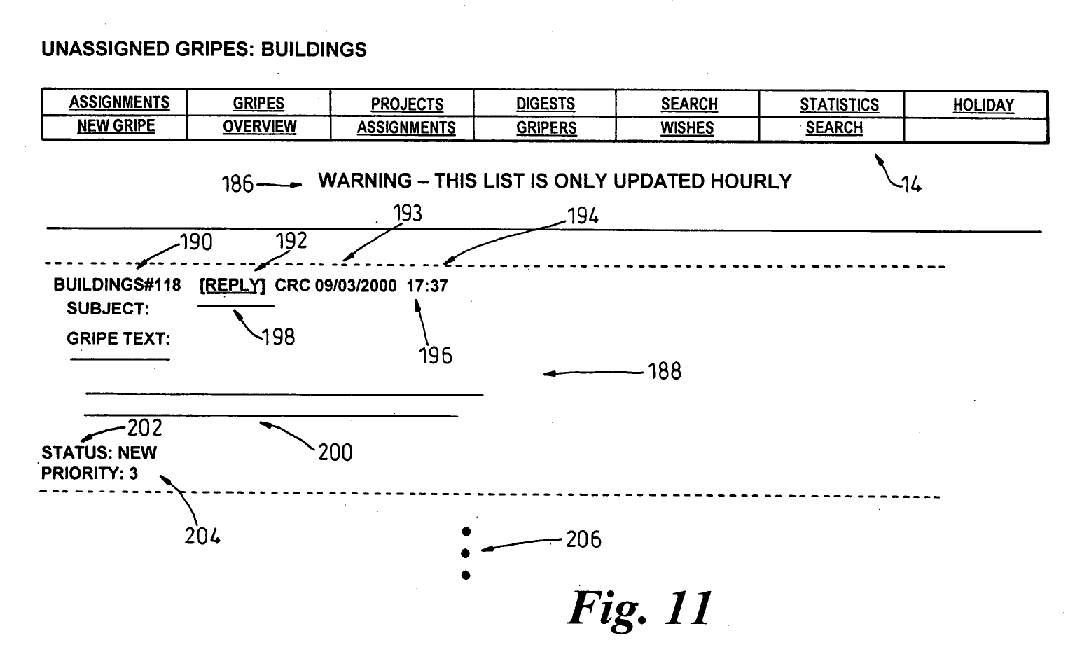

Returning to the topic overview of FIG. 4, the unassigned information records link connects to a text screen TS shown in FIG. 11. The screen TS lists the text of the information records that have not been assigned in the buildings topic. In some circumstances, the unassigned information record link may prove more useful for browsing the unassigned building information records for an overall review rather that going directly to the unassigned information record of interest via the unassigned index link on the overview screen.

The unassigned information record screen of FIG. 11 has the menu bar 14 at a top portion thereof. A warning 186 is provided below the menu bar 14 informing the user that this list is only updated hourly. Thus, users are warned as to the limitations of the system.

A list 188 of the information record text of the unassigned information records within the buildings topic then follows. This list 188 has a title line 190 that comprises the topic name together with the unique sequential number for that information record, followed by a reply link 192, followed by the initials 193 of the creator and the time 194 and date 196 at which the information record was created. In this example, the information record was created by user CRC on the 9^{th} Mar. 2000 at 17:37. The title line 190 is followed by a subject 198 of the information record that comprises the descriptive title that has been given to the information record.

The information record also includes a main body 200. A status 202 of the information record follows the text 200. In this case, the status is “new” and, therefore, the information record is unassigned. The final piece of information on this screen is a priority indicator 204 (priority one, two, or three). As indicated by dots 206, the list continues until all of the unassigned information records have been detailed.

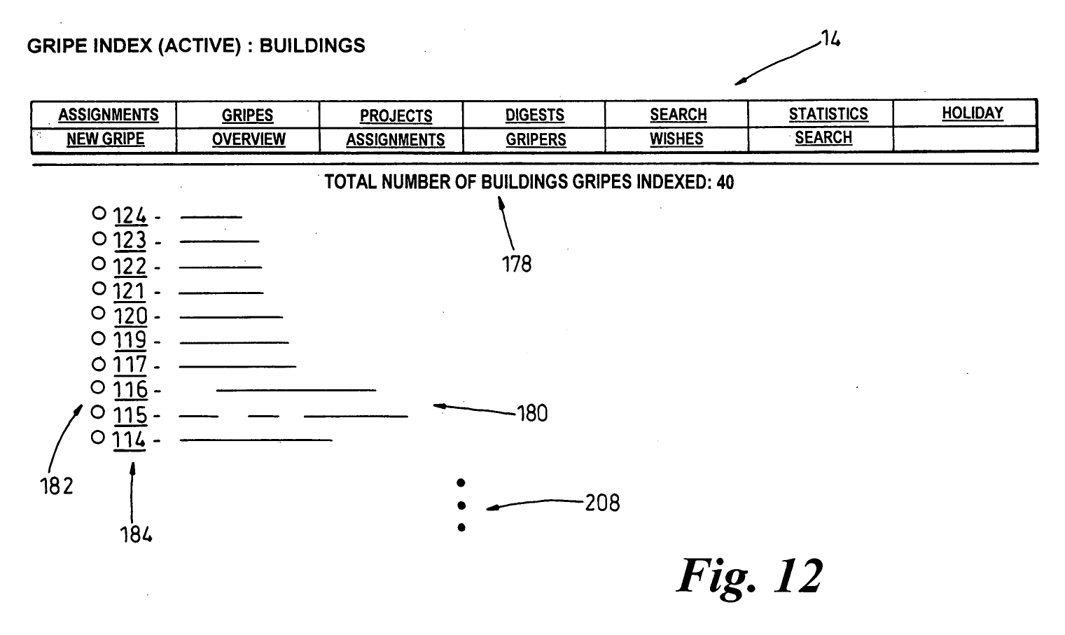

The active information record index link on the overview screen of FIG. 4 connects to a record index screen RIS shown in FIG. 12. The active information record index screen RIS is similar to the unassigned information record index of FIG. 10, and like parts have been referenced with the same reference numerals. On the building topic active index, there are forty information records, reflected in the statement 178. For ease of reference, only the first ten of these information records have been listed. It should be noted that the list of information records appears in numerical order (the newest and highest sequentially numbered appearing at the top of the list).

Gaps appear in the list 180 that correspond to information records that have another status and therefore appear in another index. For example, there is no information record number 118 since this has an unassigned status and, therefore, appears on the unassigned index of FIG. 10. The list 180 continues as is indicated by the dots 208 until all of the active building information records have been listed.

The active information records link on the building topic overview of FIG. 4 connects to an active records screen ARS, shown in FIG. 13. The screen ARS is similar in format to the screen to which the user is taken from the unassigned information records link on the topic overview screen shown in FIG. 11. Like parts have been referenced by similar reference numerals. In this example, it can be seen that building topic information record number 124 appears in the title line. This information record was created by user TXG on the 13^{th} Mar. 2000 at 14:12. The active status is reflected in the status line 202 where the assignee's initials appear. As with the information record shown in FIG. 13, building information record#124 has a priority 204 of three (a low priority).

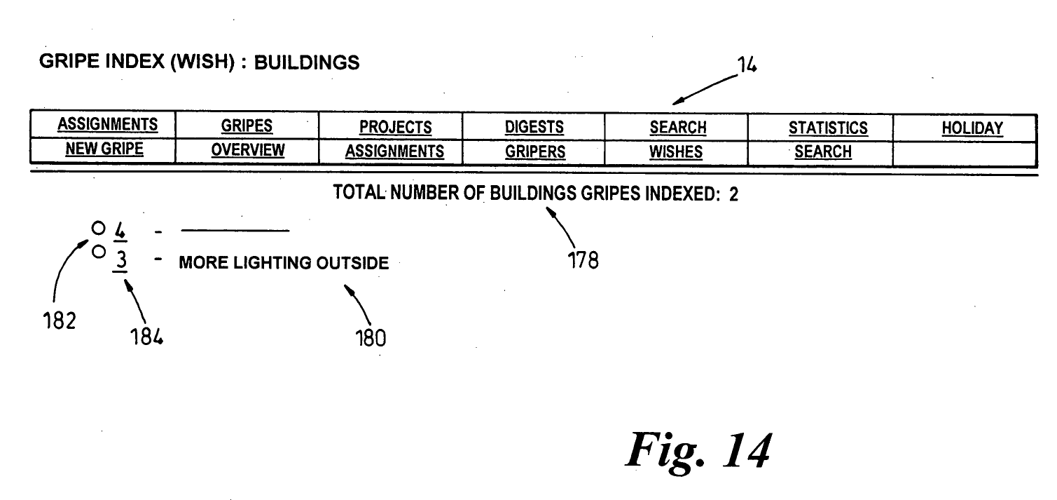

The Wish information records index link on the buildings topic overview of FIG. 4 connects to a information record index (wish) buildings screen WBS, shown in FIG. 14. The wish buildings screen WBS shows an index of all information records within the buildings topic that have a wish status. This screen is similar to the screen of FIGS. 10 and 12 and like parts have been given the same reference numerals.

It will be seen from FIG. 14 that the buildings topic, in this example, has two information records at wish status and this is reflected in the statement 178. Since there are only two information records having this status the list 180 is short and both lines have therefore been shown.

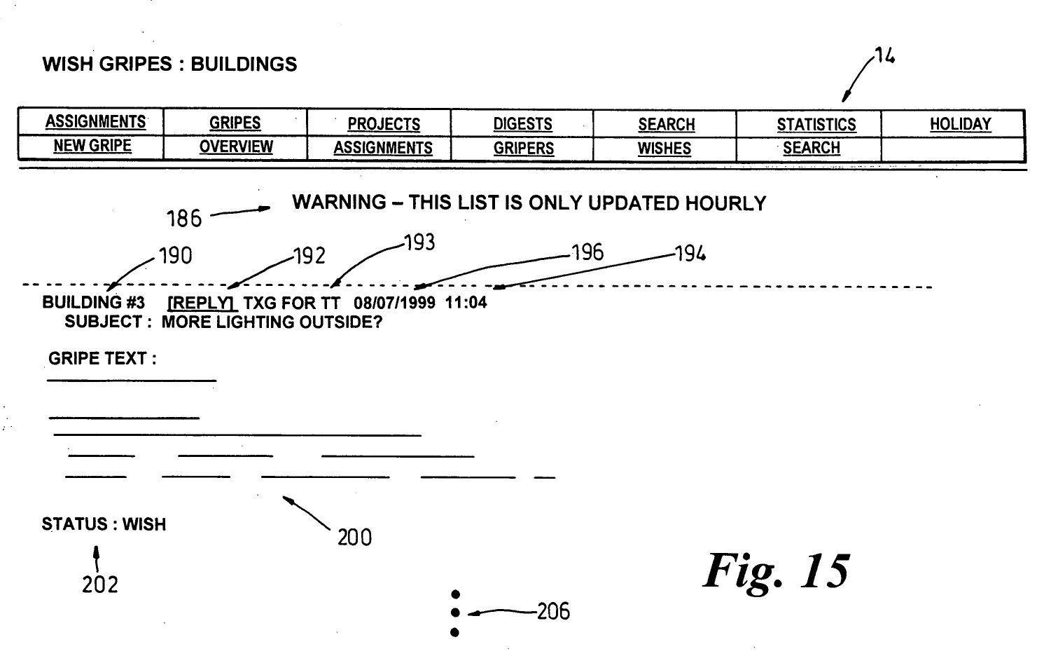

The Wish information records link on the topic overview screen of FIG. 4 connects to a wish information records screen WIRS shown in FIG. 15. The screen WIRS is similar to the screens shown in FIGS. 11 and 13 and similar parts are referenced by similar reference numerals. It will be noted that because the screen shows an information record with a wish status that there is no priority rating.

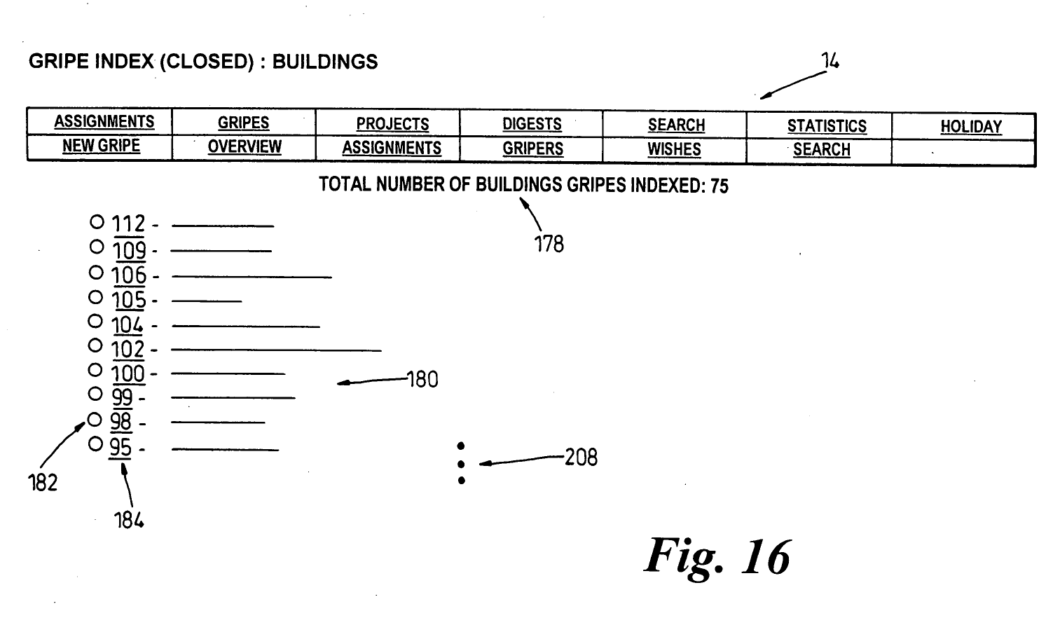

The Closed Index link on the building topic overview screen of FIG. 4 connects to an index of closed building topic information records CR, shown in FIG. 16. FIG. 16 is similar to the indexes for the unassigned, active, and wish information records shown in FIGS. 10, 12, and 14, respectively. Like parts are noted by the same reference numerals.

On the topic overview screen of FIG. 4 there is no Closed information records link connecting to a list of the complete text of the information records that have been closed. A user can access the text of a closed information record from the topic Overview screen. To do this the user must activate the Closed Index link, and then activate a link from the Index Screen (shown in FIG. 16) to a specific information record. The link to the specific information record is provided by the unique sequential number for each information record listed (column 184).

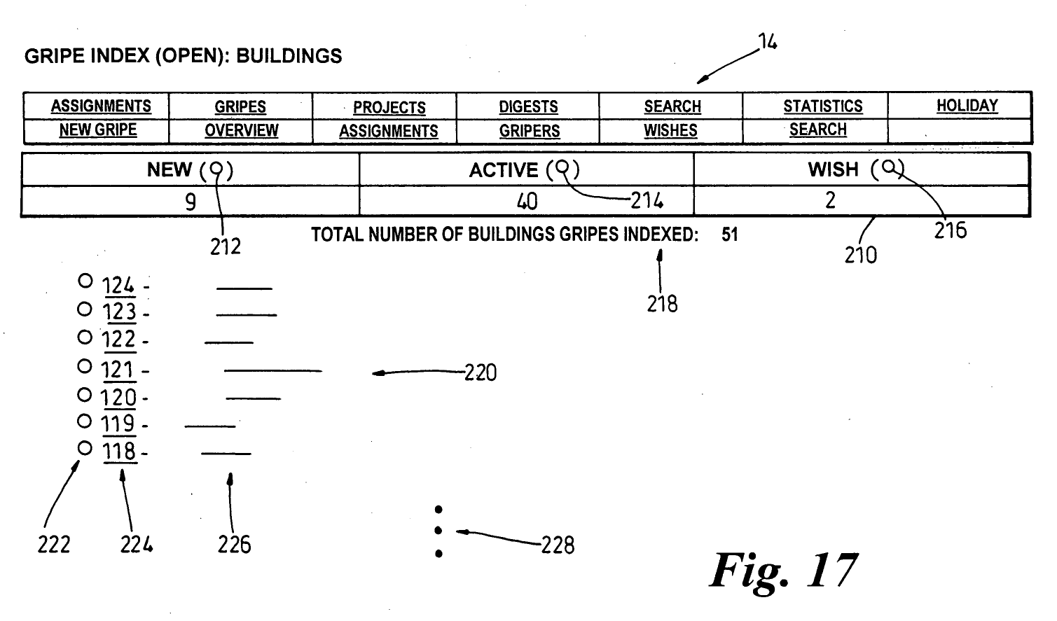

The Open Index link on the topic overview screen of FIG. 4 connects to an open index screen OIS (FIG. 17). Although similar to the index screens of FIGS. 10, 12, and 14 the screen OIS is different. The menu bar 14 appears at a top region thereof. Below the menu bar 14 there is an open information record summary table 210 that summaries the number of new, active, and information records having a wish status. In the example shown, there are nine new building information records, forty active information records, and two information records having a wish status.

Colored icons (212, 214, and 216) are provided adjacent each of the categories of the information records within the open information record summary table 210. The colors of these icons are chosen to be clearly distinguishable from one another. Below the open information record summary table 210 is a statement 218 as to how many open information records there are in the topic; fifty-one in the buildings topic. Below the statement 218 is a list 220 of the information records within the topic. The list 220 (as with the lists of FIGS. 10, 12, and 14) includes a column of icons 222, a column of the unique sequential number 224 assigned to a particular information record, and a subject heading 226 of the unique sequential number.

The column of icons 222 acts, as with the other indexes, as a link to a reply screen. However, rather than simply being a column of identical icons, the icons are given the color of the icons 212, 214, and 216 associated with a particular status (new, active, or wish). This allows a user to immediately see the category of the information record within the list 220. The list 220 is longer than shown in the FIG. 17 as indicated by the dots 228. Further, as with the other indexes the unique sequential number acts as a link to the text of the information record in question.

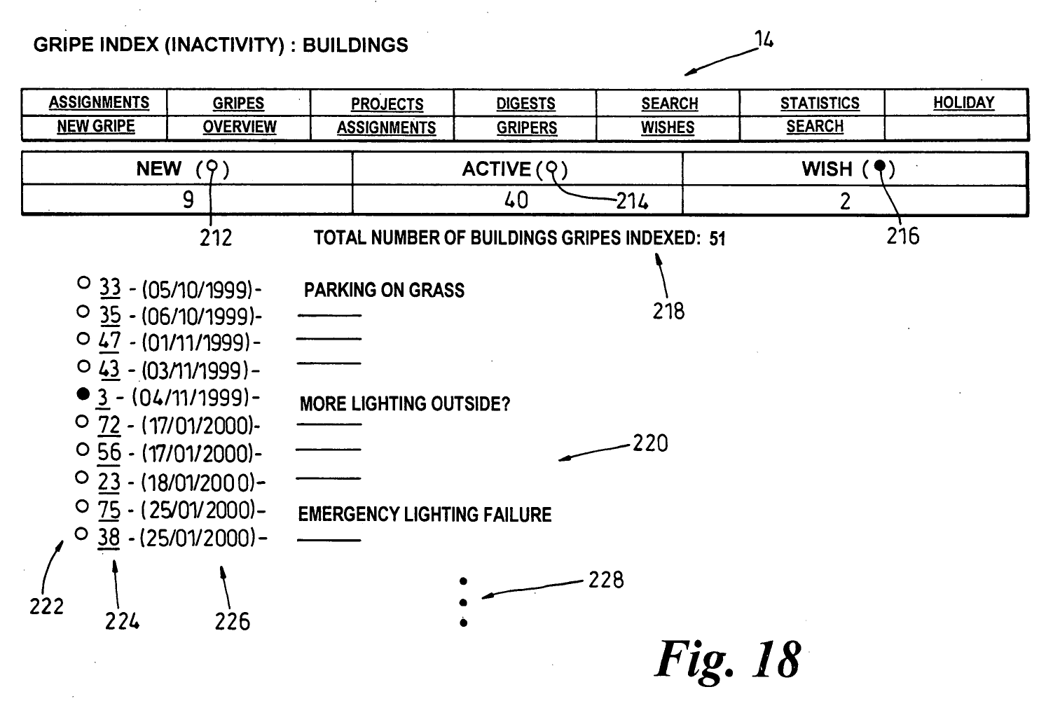

The Inactivity Index link on the topic overview screen TO connects to a time index screen TIS shown in FIG. 18. The time index screen TIS is based upon the length of time that a particular information record within the building topic has been inactive. The index is similar to the index of open information records shown in FIG. 17 and, like parts have been given the same reference numeral. It should be noted that only open information records are indexed on the screen TIS. Therefore, the statement 218 shows the same number of information records as the open index of FIG. 17. However, the information records appear in a different order with those that have been inactive, i.e., not modified, for the longest period, at the top of the list. Otherwise, this index is the same as the open index. It should be noted that the information records of all three statuses appear in this index as indicated by the colors of the icons in the column 222.

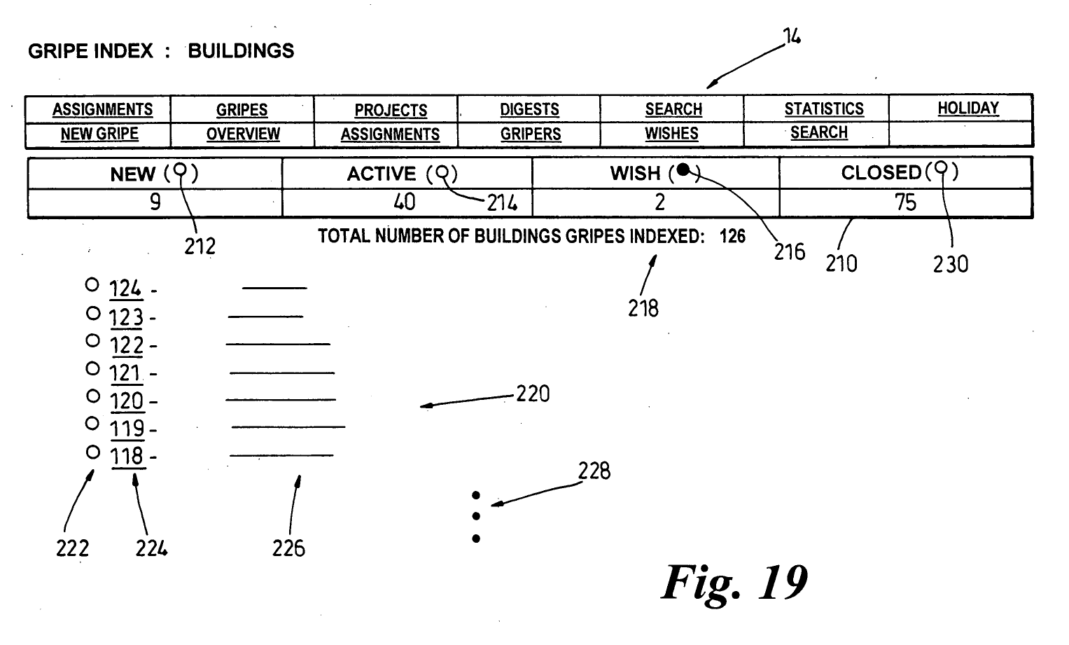

The information record Index link on the building topic overview screen TO of FIG. 4 takes the user to a topics created index screen TCIS shown in FIG. 19. The information record index screen TCIS is similar to the indexes shown in FIGS. 17 and 18, but lists all of the information records that have been created in the buildings topic. Parts of the index that are the same as those shown in FIGS. 17 and 18 are indicated with the same reference numerals. Closed information records are also included because this index lists all of the information records that have been created (FIGS. 17 and 18 only include open information records). Therefore, the summary table 210 includes a fourth column indicating that there are 75 closed information records within the building topic. A fourth color is assigned to an icon 230 associated with the closed information records. The fourth color allows closed information records to be readily seen within the column of icons 222. The list 220 of information records is ordered according to the unique sequential number assigned to each information record that appears in the column 222 of the list 220.

FIG. 21 shows a screen R that allows a reply to be made to each of the information records on the system. The screen R can be reached from any of the many reply links on the other screens. These links include the columns of icons 182 and 222 that appear on the index screens as well as the links 192 that appear on the listing of the text of the information records.

As shown in FIG. 21, screen R is designed to allow a user to make a reply to the buildings#124 information record. The standard menu bar 14 appears at a top region of the screen. Below the menu bar 14 is a new text input box 232, having a plurality of text lines and a vertical scroll bar. The new text box 130 allows the user to add to the existing text of the information record. The text that is entered therein is added to a top of the information record text and is time, date, and author stamped, providing an audit trail so that it can be seen how the information record was progressed.

Below the new text input box 232 is a quick status drop down box 234 that allows the status to be changed. As shown, the status defaults to an arrow that if accepted leaves the assignment of the information record unchanged, i.e., assigned to user TXG in this case. If the drop down box is activated the user is presented with a list of further options: remove me, NEW, wish, closed, an entry on the list to assign to each of the assistant administrators and topic administrator of the topic, and an entry on the list to make the information record a wish status to each of the assistant administrators and topic administrator.

These particular options have the following effects:
remove me: removes the current user from the assignments list. If that particular user is the only assignee then the information record is automatically classified as unassigned, which the topic administrator should act on appropriately.
new: indicates a new information record, which is not assigned to anyone.
assigned (followed by initials to which assignment is being made):

indicates that a specified user is expected to perform some action for the given information record. (The assigned keyword is optional and is automatically assumed by the system if no other status keyword is entered. Therefore, a user can simply enter the relevant users initials to have the information record assigned to that user).
Wish: has a similar effect as the assigned status in that the information record is assigned to a user, but the contents of the information record are thought to be worth completing in the long term, but of low importance in the short to medium term. Therefore, the information record is effectively thought of as being inactive, and so does not appear on the active assignments page. However, information records having a wish status can be viewed by activating wishes links.
closed: indicates that no further action on the information record is required. That is, the work detailed therein has been completed.

It is possible to assign information records to virtual users, i.e., users that do not actually exist. Such a virtual user would appear on the assignments list under a heading for that user, but only real users have a specific assignment list generated for them, e.g., the specific tables shown in FIG. 6.

A priority drop down box 236 is provided and allows the user to assign priority one, two, or three to the new text being added to the information record. A due date text input box 238 is provided and allows a user to enter a due date by which time the work described in the new information record should be completed. A reply button 240 is provided that when pressed submits the reply to the system. Finally, the reply screen shows the current text of the information record 242 that comprises the features as shown in FIGS. 20 and 27.

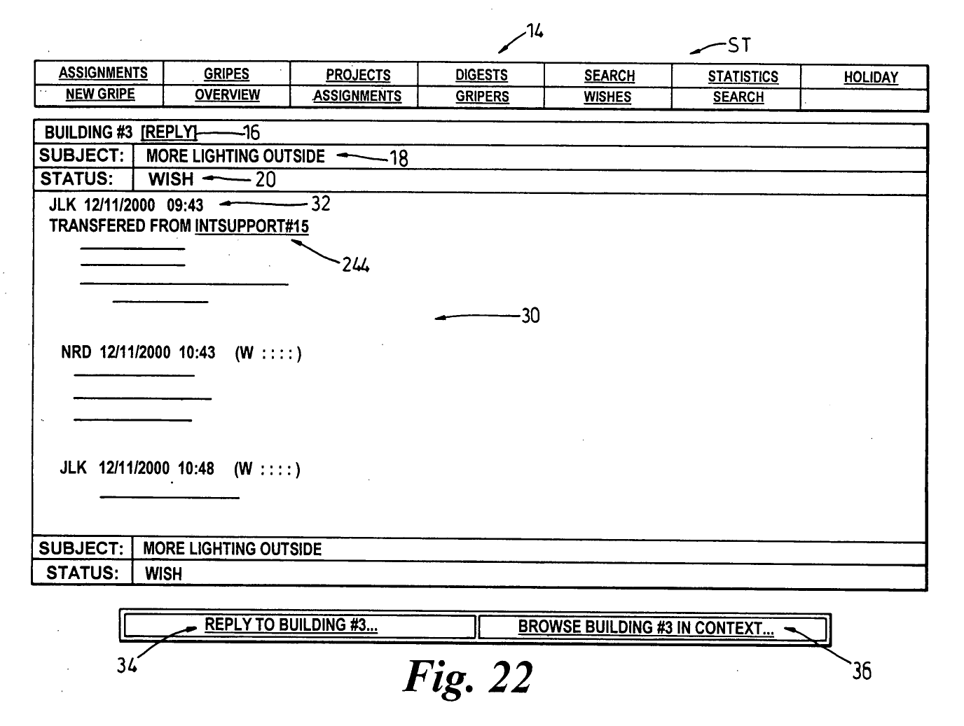

An information record having a wish status is shown in FIG. 22. The record has similar fields to the information records illustrated in FIGS. 20 and 27 and similar parts are referenced by the same reference numerals.

In the information record shown in FIG. 22, has no assignee 22, effort 24, or due date field 28. Further, the information record of FIG. 22 has been transferred into the building topic from an internal support. An Intsupport link 244 is provided that allows a user to move to a screen showing the original information record in the internal support topic.

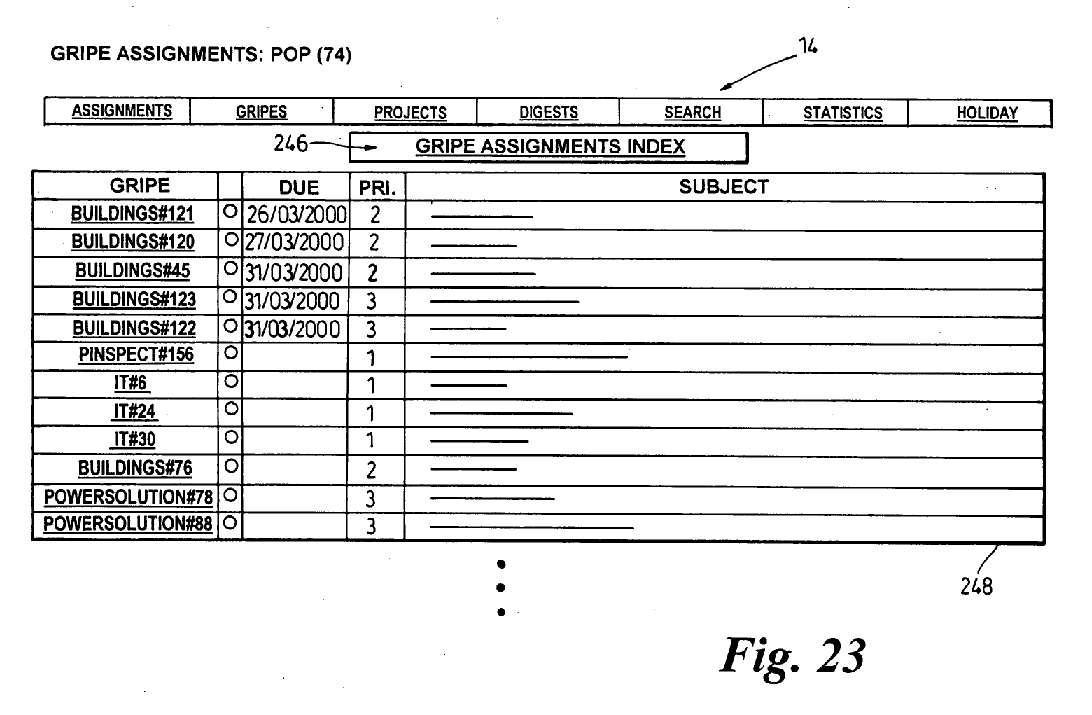

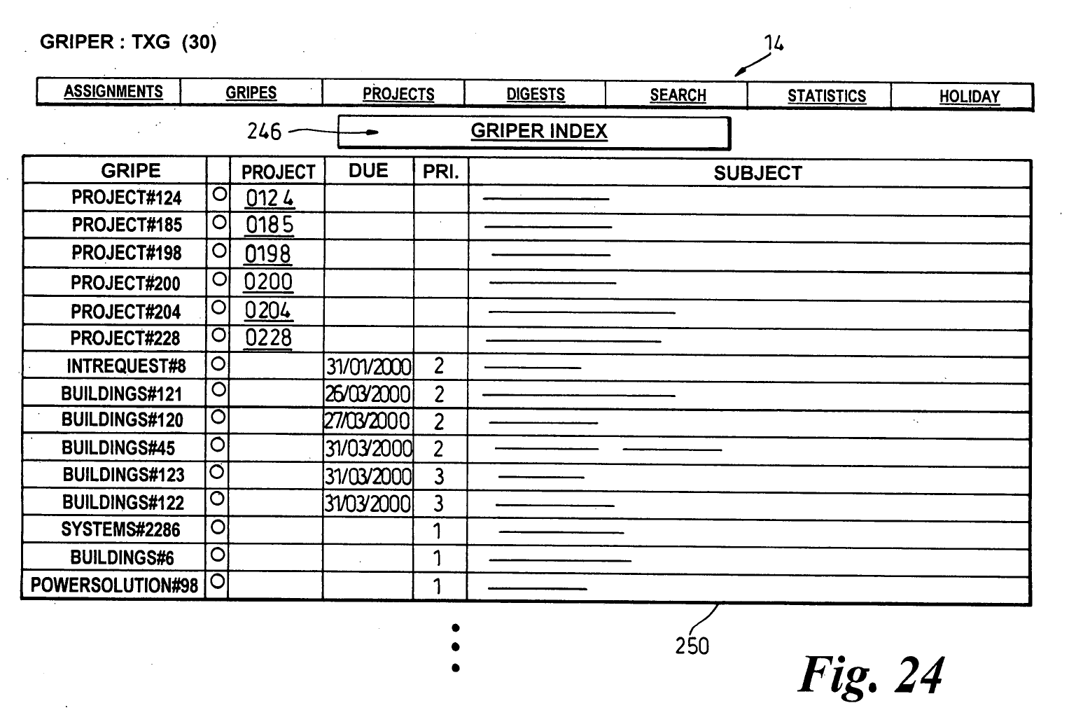

Each of the user initials shown in the Assignments table 8 of FIG. 2 acts as a link to a summary screen showing the information records that have been assigned to that user. Such a summary screen is shown in FIG. 23. Similarly, each of the users initials in the information records table 10 shown in FIG. 2 acts as a link to a summary screen showing the information records that that user has created. Such a summary screen is shown in FIG. 24.

The screens of FIGS. 23 and 24 are similar to one another, and each has a menu bar 14 at top region thereof. On these screens the menu bar 14 comprises a single line containing the seven links that appear on the home screen (assignments, gripes, projects, digests, search, statistics, holiday). This is because this screen is not directly related to a single topic and, therefore, the topic portion of the menu bar 14 is not relevant. Under the menu bar 14 is a link 246 that takes the user back to the index from which from which they accessed the summary screen. In the case of FIG. 23 the link 246 takes the user back to the information record assignments index, and in the case of FIG. 24 the user is taken back to the information records index. Each of the screens also includes a table 248, and a table 250 containing summary information. These tables each have a plurality of columns, the number of which can vary depending on the type of information records that a particular user has associated with him or her.

The table 248 includes five columns: a first containing the information record topic and unique sequential number within that topic; a second providing an icon that acts as a link to the reply screen; a third column covering any due date for the information record; a fourth column showing the priority of the information record; and a fifth column containing the descriptive title for the information record. The information record topic and unique sequential serial number in the first column of the Table act as links to the text of that particular information record. The information records within the table are placed into two categories: those with due dates and those without. The category of information records having a due date is presented before those without. Within each category the information records are ordered according to their priority so that the highest priority information records appear first.

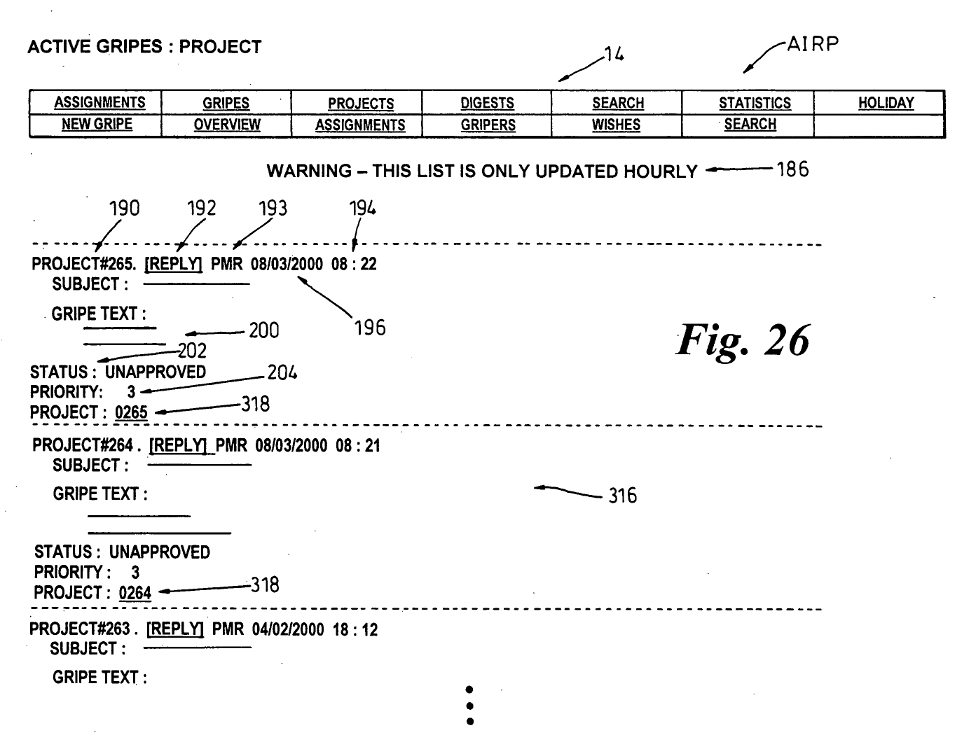

In the table 250, an extra column is provided that contains information relating to projects. As discussed, a project can contain a number of information records in different topics and allows a particular project of work to be managed. Generally, a project line in the table does not, therefore, contain any priority or due date information since it relates to a number of information records that can each have a different priority and due date. This field can be used to state when the topic is expected to be completed. Each information record in the project topic only gives an overview of the situation, which could be, for instance, discussed at management meetings. The day-to-day running of the project is handled by many information records which break the project down into smaller portions. Each project page pulls this information together to allow the project to assess the state of the project. If project information is provided, the extra column contains the four-digit project number and acts as a link to the project summary page shown in FIG. 26. The project#NNNN link that is provided for the topic and unique sequential number information for a project takes the user to a screen detailing the project. Any entries to the table containing project information are ordered before the non-project related information records and as such occur at a top region of the table 250.

As shown in FIG. 2, a complete summary link is provided below the assignment table 8 and the information records table 10. This link takes the user to a screen (not shown) summarizing all of the users of the system. The “complete summary” is provided as a series of tables, one for each user of the system. The tables on the complete summary screen are similar to those shown in FIGS. 23 and 24.

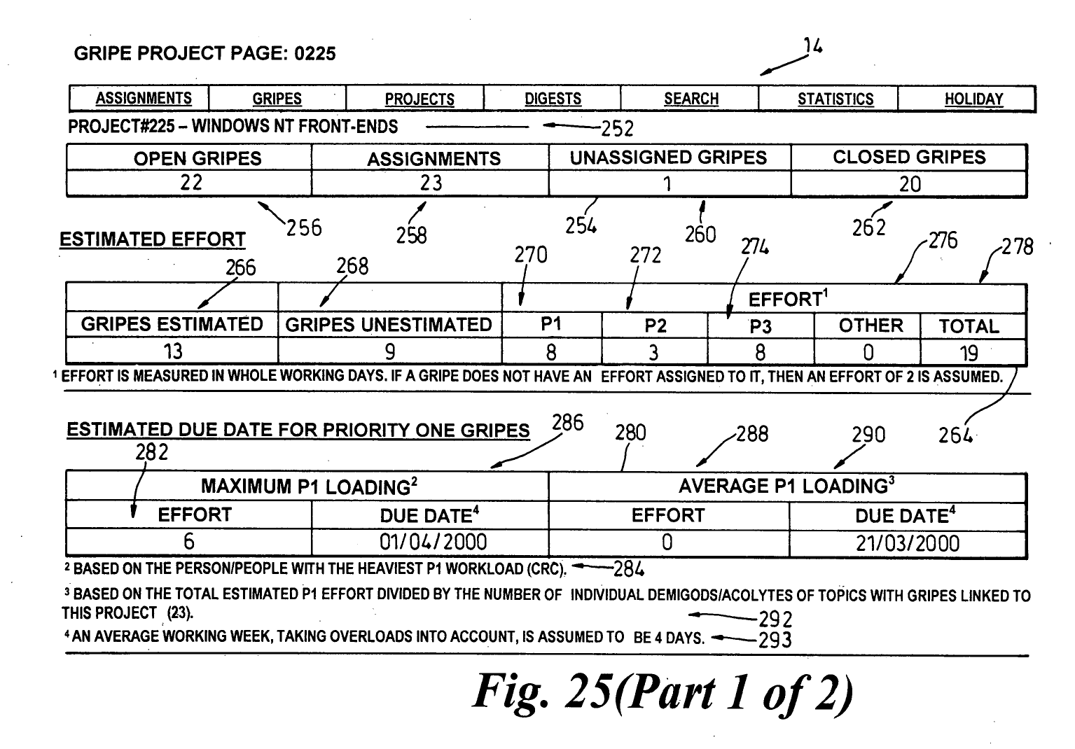

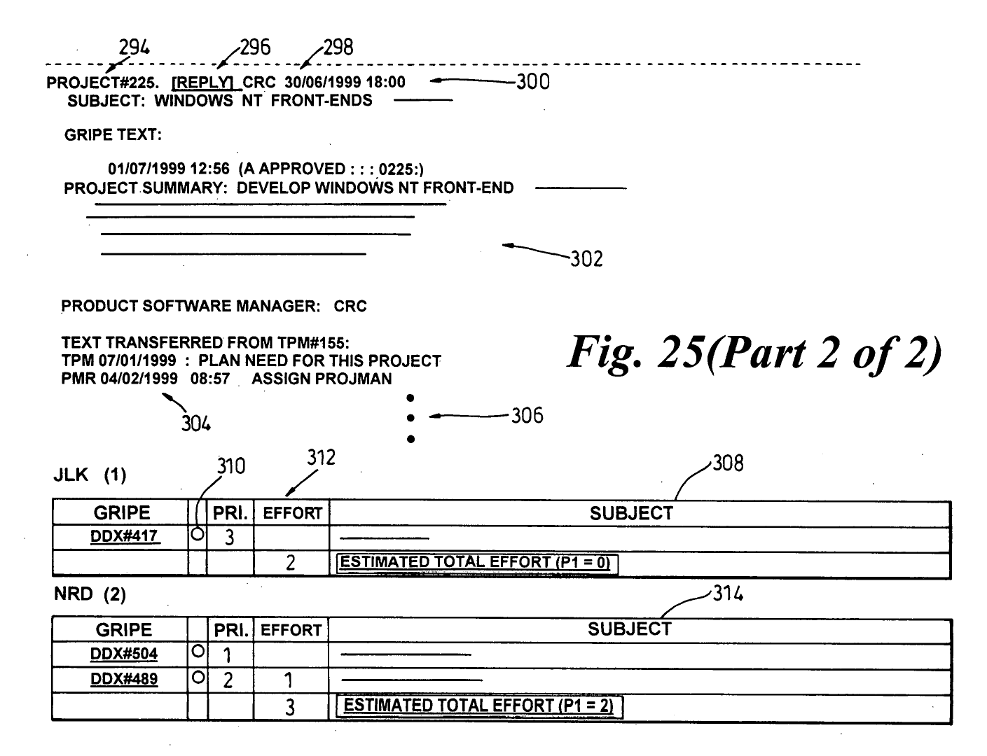

Activating a link to a project provided by the four-digit project code takes a user to a project summary screen PSS, as illustrated in FIG. 25. The project summary screen PSS, provides a summary of the particular project. The project summary screen PSS includes the first line of the menu bar 14 at a top region thereof. The second, topic specific, line of the menu bar is not applicable because the information presented on this screen is not associated with a particular topic. Below the menu bar 14 is a heading 252 for the project providing a descriptive title. The heading 252 is followed by an information record summary table 254 showing the number of open information records 256, the number of assignments 258 that have been made (noting that a single information record can be assigned to more than one person), the number of unassigned information records 260, and the number of closed information records 262 within that particular project.

Below the information record summary table 254, the screen shows an effort summary table 264 that summarises the estimated amount of work for the information records within the project. The information record summary table 254 comprises seven columns. The first two columns 266 and 268 respectively, summarize the number of information records that have had an effort estimate made and those that have not had an estimate made. The total of these two columns equals the number of open information records within the project.

The next three columns show, respectively, the estimated effort for the information records that have been given a priority one status 270, priority two status 271, or priority three status 272. The efforts are estimated in whole numbers of days and if an information record does not have an effort assigned thereto, an effort of two is assumed.

The final two columns 276 and 278 show the estimated effort for information records in categories other than priority one, two, or three, (i.e., for information records that have not been prioritized) and the total amount of effort that has been estimated for the work in this project, respectively. In this case, the total amount of effort for the project is shown to be nineteen days. Below the effort summary table 264 is an additional effort summary table 280, which summarizes the loading of people who have been assigned work in the project. The maximum effort column 282 of the table shows the maximum loading of any one person that has been assigned work in this particular project. As indicated in the note 28, this is based upon the person having the highest number of priority one information record assignments. The due date for these efforts is shown in the second column 286 of the effort summary table.

In the example shown, the maximum loading is based upon the user CRC (as can be seen in the note 284) who has six days worth of work assigned from this project with a due date of 01/04/2000. (To calculate the maximum loading the effort for all the information records linked to the project and assigned to each person are added up. The person/people with the largest effort are said to have the maximum loading.) The third and fourth columns 288 and 290 of the effort summary table show the average loading of people who have been assigned information records within this project. It will be noted that the average effort is zero with a due date of 21/03/2000. (The average loading is calculated by adding the effort for all of the information records linked to the project and divided by the number of assistant administrators plus one (to include the topic administrator)).

Below note 284 there are two further notes: A note 292 indicates that the average loading shown in the third column 288 is based on the total effort assigned to priority one information records within the project divided by the number of individual topic administrators/assistant administrators of topics with information records linked to this project. A second note 293 indicates that an average working week, taking overheads into account, is assumed to be four working days.

After the summary tables 264 and 280 and notes 284, 292, and 293, the text of the project is provided. The layout of this text is similar to that of the information records as described hereinbefore. The project text includes a heading 294 (in this case project#225), followed by a reply button 296, initials 298 of the creator of the project followed by a time and a date 300. The project text 302 follows, and is built up of replies and comments on previous parts of the project text 302. Each addition to the project text is time, date, and author stamped (as shown in box 304) to provide a record of how the project progressed. As indicated by the dots 306 the project text has been abbreviated for conciseness.

(It should be noted that the project “topic” is similar to any other information record and anyone who is an assistant administrator can open a project information record. However, the topic administrator can close the information record if the opening of a project is not approved).

Following the project text 302 is a summary table for each of the users that have been assigned work on information records within this particular project. The first of these summary tables 308 is for the user JLK and shows that user JLK only has a single information record assigned, information record ddx#417 having a priority of three. A link to ddx#417 is provided together with a reply link (by the icon 310 in the second column).

It can be seen that an effort of two has been assigned to this information record. This effort has been assigned by default since no actual effort has been assigned in the effort column 312 associated with information record ddx#417. (Information records for which no effort estimate has been provided are automatically assigned an effort of two.) Further, it will be noted that because information record ddx#417 is not a priority one information record and is the only information record assigned to JLK that the estimated effort for priority one information records is zero.

Next is a summary table 314 for user NRD who has two information records (ddx#504 and ddx#489) assigned thereto. Ddx#504 is a priority one information record, but has no effort assigned to it. Ddx#489 is a priority two information record and an effort estimate of one assigned thereto. Therefore, the total work estimate in the last row is three. The summary table 314 also reflects that the total estimate of priority one information records is two (the default setting since ddx#504 does not have an effort estimate assigned thereto).

It is possible to view the text of a project on a screen similar to that shown in FIGS. 20 and 27, although no such screen is shown. On such a screen, there is a browse project in context link that takes the user to an active information records project screen AIRP as shown in FIG. 26. The AIRP screen includes a list 316 of the texts of all of the projects that have been created. The AIRP screen is similar to the list of information records that appear in FIGS. 11 and 13. Like parts have been labelled with the same reference numerals.

The text of the projects in the AIRP screen includes a project line 318 indicating the project number. The four-digit project number NNNN in the project line 318 provides a link to the specific screen for that project.

In environments where computer code is generated, the information system can be used to track the development of such code. Bugs, or problems, that arise with the code can be noted and assigned to a user to fix. The steps taken to fix the problem are then noted to complete the audit trail, and a link to the new code fragment is inserted in one word to the information record to complete the audit trail.

As discussed above, the information system makes use of both email and hypertext link technologies in order to manage the information records, or Gripes, contained therein. The hypertext link aspect has now been described and now the email-based portion will be described.

As information records are added to the system, or modified, the users registered with that particular information record topic are notified automatically by email as to the changes. The format of this notification depends on the level of registration that that user has with the system. Topic administrators, assistant administrators, and passive participants are automatically sent an information record notification email message when an information record is created or modified within a topic with which they are registered. As will be appreciated, if the user is registered with a large number of topics then this can result in a large number of email messages. Registration as a digest recipient reduces the amount of information a user receives because a digest recipient receives only a summary of all the information records that have changed. Each information record notification email message, for ease of reference, contains at a top region thereof the text that has been added to the information record. The information system also automatically adds to the email the time and date at which the information was added and the initials of the user that created the addition. The project status is also automatically included. After this information has been presented the remainder of the text of the information record is included for ease of reference of the user receiving the email. The full text of the information record allows the history of the information record to be seen.

Each information record notification email has associated with it two hypertext links. A first of these hypertext links takes a user to the screen showing the text of the information record (for example, as shown in FIGS. 20 and 27). The information record notification email contains the information shown on this screen, but the screens with the full information record text allow a user to link to other screens. A second of the hypertext links takes the user to a reply screen where a reply can be made to the modified, or new, information record.

The email-processing program used to receive information record emails is modified so that there is a specific folder into which email messages relating to information records are directed. It will be appreciated that it is usual for new email messages to be directed into an inbox so that it clear to a user that an email has arrived. The use of the information record folder is convenient since it is clear that information record information has arrived.

Users of the system are sent a weekly email by the information system reminding them about the information records having outstanding actions that they have assigned to them. Topic administrators can update information records in a manner that suppresses the sending of emails relating to that change. This feature is useful since is allows information records to be updated without causing a large number of emails to be sent.

As noted above, it is possible for users to cause the information system to enter a holiday mode in relation to the account associated with that user. The holiday mode disables certain types of email that would normally be sent to that user by the system. The holiday mode disables the following types of email: new information records and information record updates from topics of which your are the topic administrator; new information records and information record updates from topics of which you are a passive participant; New information records and information record updates which are assigned to you; and topic daily digests.

When a user returns from holiday they can disable the holiday mode and, thus, re-activate the information record email system. The information system then causes an email to be sent that contains a list of information records that have been updated whilst that user had the holiday mode enabled.

As can be seen from the above, the invention provides a system and method of information management. However, the invention is not to be limited to the examples provided and encompasses all of the subject matter set out in the appended claims.

1. A method of allowing a group of uniquely identified users to track at least one task, the method comprising:
connecting two or more computers in a network to form an information system;
generating one or more information records each detailing at least one task and maintaining the records in a database;
establishing classes of users, each class of users having different rights in relation to said information records;
assigning each user a unique identity and at least one class;
associating said information records with one or more of said uniquely identified users;
providing access to said database from at least one of said computers in said network;
allowing at least one predetermined uniquely identified user to add to said information record, such that said information record reflects the history of the task that it details; and
alerting with an electronic communication each of said uniquely identified users that is associated with one of said information records when said one information record is modified
wherein the electronic communication is tailored according to the at least one class of user in which the uniquely identified user has been placed for a task category of the task for which the electronic communication was sent.

2. A method of processing information, thereby facilitating the tracking of a task, the method comprising:
maintaining a database of information records each detailing at least one task on a central server;
accepting signals from at least one remote computer;
if said signals cause any of said information records to be modified causing an electronic communication to be sent to one or more users of the system alerting said users about the modification of said information record; and
updating said information record to maintain a record of the modification to that said information record.

3. A method of maintaining an information database maintained to track at least one task, the method comprising:
allowing one or more users each having assigned thereto a unique identity to access a remote database comprising one or more information records each record detailing a task;
allowing said information records to be viewed and/or modified and subsequently causing signals to be sent to said remote database updating said database accordingly; and
arranging to receive electronic communications from said remote database indicative that information records that are associated with said uniquely identified users have been modified.

4. A system arranged to track at least one task, said system comprising:
two or more computers connected to one another to form a network;
the system being arranged such that users thereof are given a unique identity and assigned a class;
at least one memory means arranged to hold a database of information records, with each record detailing at least one task and being associated with at least one said uniquely identified user;
said system being arranged such that each said computer provides access to said database held on said memory means and allows at least one information record to be at least one of viewed and modified;
said system being arranged such that said information record is added to, to reflect any such modification, such that a history of the task is maintained; and
said system being arranged such that an electronic communication is sent to said uniquely identified user associated with a said information record should said information record be modified
wherein the electronic communication is tailored according to the class of user in which the uniquely identified user has been placed for a task category of the task for which the electronic communication was sent.
